(19) United States
(12) Patent Application Publication
(10) Pub. No.: US 2004/0177076 A1
(43) Pub. Date: Sep. 9, 2004

(54) Information processing apparatus, image forming apparatus, and information processing method

(76) Inventor: Yohko Ohtani, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/793,797

(22) Filed: Mar. 8, 2004

(30) Foreign Application Priority Data
Mar. 7, 2003 (JP) 2003-061610
Feb. 13, 2004 (JP) 2004-036819

(51) Int. Cl. G06F 7/00

(52) U.S. Cl. 707/10

(57) ABSTRACT

An information processing apparatus includes a connection information managing part managing connection information for connecting to the information storing server, receiving a request concerning the connection information, and conducting a process corresponding to the request; and a requesting part conducting a request concerning the connection information. Thus, the connection information managing part receives one of an obtain request, an add request, a change request, and a delete request of connection information as the request, and conducts the process corresponding to the obtain request, the add request, the change request, or the delete request.

The present application is based on the Japanese priority applications No. 2003-061610 filed on Mar. 7, 2003 and No. 2004-36819 filed on Feb. 13, 2004, the entire contents of which are hereby incorporated by reference.

### BACKGROUND OF THE INVENTION

1. Field of the Invention

The present invention generally relates to an information processing apparatus, an image forming apparatus, and an information processing method, and more particularly to the information processing apparatus, the image forming apparatus, and the information processing method in that information can be obtained from an information storing server which is utilized in common by at least one information processing apparatus.

2. Description of the Related Art

Recently, in a system connecting at least one client terminal, an information storing server, an information processing apparatus and a like through the Network, the information processing apparatus can obtain information stored in the information storing server. In this case, the information processing apparatus is required to maintain connection information to connect to the information storing server.

This connection information is appropriately updated by an instruction of an operator operating the information processing apparatus. The connection information is appropriately updated by an instruction from the client terminal through the network. Since the connection information is updated by the instruction of the operator operating the information processing apparatus or the client terminal, a plurality of operators may attempt to update the connection information simultaneously. Moreover, while the connection information is utilized by an application activated in the information processing apparatus, the operator operating the information processing apparatus or the client terminal may update the connection information. Furthermore, while the connection information is updated by the instruction of the operator operating the information processing apparatus or the client terminal, the application activated in the information processing apparatus may utilize the connection information.

Accordingly, the information processing apparatus conventionally excludes an update request of the connection information from other operators and an access to the connection information by the application while one operator is updating the connection information. Moreover, the information processing apparatus conventionally excludes the update request of the connection information from the operators while the application is accessing the connection information.

The image forming apparatus as one example of the information processing apparatus includes functions as a printer, a copier, a facsimile, a scanner, and a like in a single housing of the image forming apparatus. The image forming apparatus includes four types of software corresponding to the printer, the copier, the facsimile, and the scanner in addition to as a displaying part, a printing part, an imaging part, and a like in the single housing. The image forming apparatus operates as the printer, the copier, the facsimile, and the scanner by switching the four types of software. For example, Japanese Laid-Open Patent Application No. 2002-84383 discloses an image forming apparatus as one example of the information processing apparatus.

In the conventional information processing apparatus described above, the update request from the other operators and the access of the connection information by the application are excluded until the update of the connection information by the operator ends when the operator updates the connection information. Accordingly, in the conventional information processing apparatus, a waiting time is long until the update of the connection information by the other operators, and the access of the connection information by the application becomes available. Thus, process efficiency is deteriorated.

### SUMMARY OF THE INVENTION

It is a general object of the present invention to provide an information processing apparatus, an image forming apparatus, and an information processing method in which the above-mentioned problems are eliminated.

A more specific object of the present invention is to provide the information processing apparatus, the image forming apparatus, and the information processing method in that an update or an access of the connection information can be effectively conducted.

The above objects of the present invention are achieved by an information processing apparatus capable of obtaining information from an information storing server utilized in common by a least one information processing apparatuses, comprising: a connection information managing part managing connection information for connecting to the information storing server, receiving a request concerning the connection information, and conducting a process corresponding to the request; and a requesting part conducting a request concerning the connection information; wherein said connection information managing part receives one of an obtain request, an add request, a change request, and a delete request of connection information as the request, and conducts the process corresponding to the obtain request, the add request, the change request, or the delete request.

The above objects of the present invention are achieved by an information processing apparatus capable of obtaining information from an information storing server utilized in common by a least one information processing apparatuses, including: a connection information managing part managing connection information for connecting to the information storing server, receiving a first request using the connection information, and sending a second request of conducting a process corresponding to the first request to the information storing server corresponding to the connection information; and a request sending part sending a third request using the connection information, wherein said connection information managing part receives a search request as the third request from the request sending part and searches for information stored in the information storing server in response to the search request.

The above objects of the present invention are achieved by an image forming apparatus including at least one hardware resource used in an image forming process, at least one program conducting a process according to an image form, and a platform managing a use of the hardware resource by said at least one program, including: a connection information managing part managing connection information for connecting to an information storing server utilized in common by at least one image forming apparatus or information processing apparatus, receiving a request concerning the connection information, and conducting a process corresponding to the request; and a requesting part conducting a request concerning the connection information, wherein said connection information managing part receives one of an obtain request, an add request, a change request, or a delete request of connection information as the request, and conducts the process corresponding to the obtain request, the add request, the change request, or the delete request.

The above objects of the present invention are achieved by an image forming apparatus including at least one hardware resource used in an image forming process, at least one program conducting a process according to an image form, and a platform managing a use of the hardware resource by said at least one program, including: a connection information managing part managing connection information for connecting to the information storing server, receiving a first request using the connection information, and sending a second request of conducting a process corresponding to the first request to the information storing server corresponding to the connection information; and a request sending part sending a third request using the connection information, wherein said connection information managing part receives a search request as the third request from the request sending part and searches for information stored in the information storing server in response to the search request.

The above objects of the present invention are achieved by an information processing method conducted by the information processing apparatus capable of obtaining information from an information storing server utilized in common by a least one information processing apparatuses, comprising the steps of: receiving a request concerning connection information for connecting to the information storing server; and receiving a request concerning the connection information and conducting a process corresponding to the request, whereby one of an obtain request, an add request, a change request, and a delete request of connection information is received as the request, and a process corresponding to the obtain request, the add request, the change request, or the delete request is conducted.

The above objects of the present invention are achieved by an information processing method conducted by the information processing apparatus capable of obtaining information from an information storing server utilized in common by a least one information processing apparatuses, comprising the steps of: receiving a request using connection information for connecting to the information storing server; requesting a process corresponding to the request to the information storing server corresponding to the connection information; and receiving a request response from the information storing server corresponding the connection information, whereby a search request is received as the request, information stored in the information storing server is searched for in response to the search request.

According to the present invention, a request concerning connection information and/or a request using the connection information are received, and a process corresponding to the request is conducted. Moreover, according to the present invention, the connection information is managed by associating with a generation number, which is changed at each update. As a result, it is possible to utilize a determination result showing a match or mismatch of the generation included in the request with the generation number associated with the connection information. Therefore, without an exclusive access control of the request concerning the connection information and the request using the connection information, it is possible to conduct a process corresponding to the process.

### BRIEF DESCRIPTION OF THE DRAWINGS

In the following, embodiments of the present invention will be described with reference to the accompanying drawings.

FIG. 1 is a block diagram showing an information processing apparatus according to the present invention;

FIG. 2 is a block diagram showing the hardware configuration of the information processing apparatus according to the present invention;

FIG. 3 is a block diagram showing a functional configuration of the multi-functional apparatus according to the present invention;

FIG. 4 is a block diagram showing the hardware configuration according to the present invention;

FIG. 5 is a diagram for explaining an obtain request, an add request, a change request, and a delete request of the LDAP server according to the present invention;

FIG. 6 is a diagram for explaining the obtain request, the add request, the change request, and the delete request of the LDAP server according to the present invention;

FIG. 7 is a diagram for explaining a search request of the LDAP server information according to the present invention;

FIG. 8 is a sequence diagram showing the registration process for registering the LDAP server information by an instruction conducted at a screen of the clients according to the present invention;

FIG. 9 is a diagram illustrating XML data utilized in an LDAP server information registering process according to the present invention;

FIG. 10 is a sequence diagram for explaining a process for changing the LDAP server information according to a first embodiment of the present invention;

FIG. 11 is a sequence diagram for explaining another process for changing the LDAP server information according to the first embodiment of the present invention;

FIG. 12 is a sequence diagram for explaining a process for adding the LDAP server information according to a second embodiment of the present invention;

FIG. 13 is a sequence diagram for explaining another process for adding the LDAP server information according to the second embodiment of the present invention;

FIG. 14 is a sequence diagram for explaining a process for deleting the LDAP server information according to a third embodiment of the present invention;

FIG. 15 is a sequence diagram for explaining another process for deleting the LDAP server information according to the third embodiment of the present invention;

FIG. 16 is a sequence diagram for explaining a process for the operator to select the following process in a case in that both generation numbers of the LDAP server information are different each other, according to a fourth embodiment of the present invention;

FIG. 17 is an image diagram illustrating a selection screen according to the fourth embodiment of the present invention;

FIG. 18 is a sequence diagram for explaining a sequence process in that the change process for changing the LDAP server information and a process using the LDAP server information are simultaneously conducted, according to a fifth embodiment of the present invention;

FIG. 19 is a sequence diagram for explaining a first variation of the sequence process in that the change process for changing the LDAP server information and the process using the LDAP server information are simultaneously conducted, according to a sixth embodiment of the present invention;

FIG. 20 is a sequence diagram for explaining a second variation of the sequence process in that the change process for changing the LDAP server information and the process using the LDAP server information are simultaneously conducted, according to a seventh embodiment of the present invention;

FIG. 21 is a sequence diagram for explaining a third variation of the sequence process in that the change process for changing the LDAP server information and the process using the LDAP server information are simultaneously conducted, according to an eighth embodiment of the present invention; and

FIG. 22 is a sequence diagram for explaining a fourth variation of the sequence process in that the change process for changing the LDAP server information and the process using the LDAP server information are simultaneously conducted, according to a ninth embodiment of the present invention.

### DESCRIPTION OF THE PREFERRED EMBODIMENTS

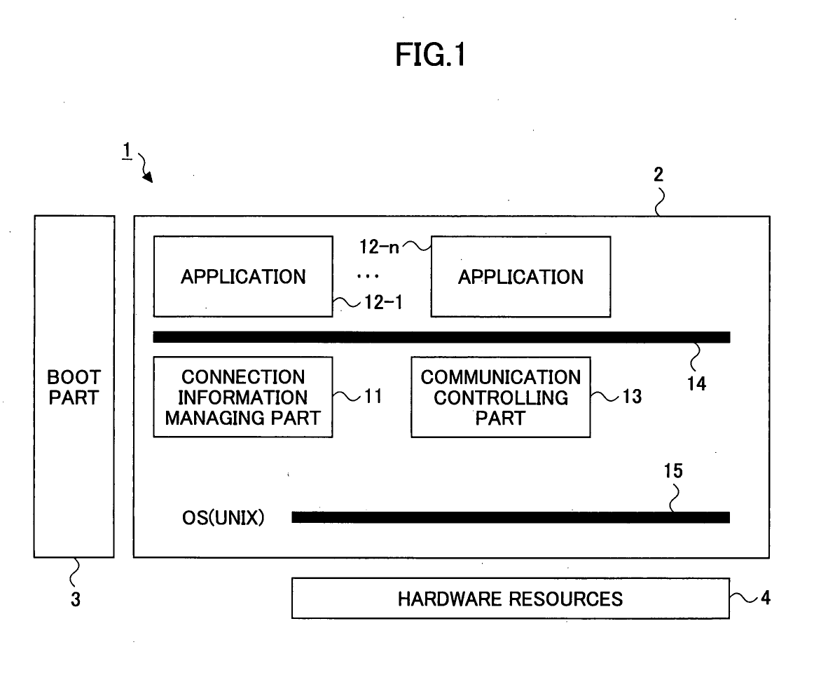

In the following, embodiments according to the present invention will be described with reference to the accompanying drawings. FIG. 1 is a block diagram showing an information processing apparatus according to the present invention. In FIG. 1, the information processing apparatus 1 includes a software group 2, a boot part 3, and a hardware resources 4.

The boot part 3 is executed first when the information processing apparatus 1 is turned on, and activates the software group 2. For example, the boot part 3 reads out programs of a connection information managing part 11, applications 12-1 through 12-n, and communication controlling part 13 from an auxiliary storage unit, transfers the programs to a memory unit to activate.

The hardware resources 4 includes hardware resources of a CPU (Computer Processing Unit), a memory unit, an interface unit, and alike. Also, the software group 2 includes programs of a connection information managing part 11, applications 12-1 through 12-n, and a communication controlling part 13, which are activated on an operating system (OS) such as UNIXT™.

The connection information managing part 11 manages connection information to connect an information storing server which is connected to the information processing apparatus 1 through a network such as the Internet or a LAN (Local Area Network). For example, as the information storing server, a server being compliant with an LDAP (Lightweight Directory Access Protocol) can be used. The information storing server manages user information as a part of various information.

The applications 12-1 through 12-n conduct an obtain request, an add request, a change request, a delete request, and a like of the connection information as requests concerning the connection information with respect to the connection information managing part 11. Moreover, the applications 12-1 through 12-n conduct a search request and a like of the connection information as requests using the connection information with respect to the connection information managing part 11. For example, the applications 12-1 through 12-n obtain the user information which is a part of all information stored in the information string server and process the user information.

The communication controlling part 13 controls a communication with the information storing server and the like. The connection information managing part 11 receives each request from the applications 12-1 through 12-n by utilizing an API (Application Program Interface) 14. The API 14 is an interface used to receive each request from the applications 12-1 through 12-n by a predetermined function.

The OS control the software of the connection information managing part 11, the applications 12-1 through 12-n, and the communication controlling part 13 in parallel. The connection information managing part 11, the communication controlling part 13, and the like issue a request to the hardware resources 4 by utilizing an engine I/F 15. The engine I/F 15 is an interface used to send the request to the hardware resources 4 by a predetermined function. The connection information managing part 11 corresponds to a connection information managing part in claims, and the applications 12-1 through 12-n correspond to a requesting part in claims.

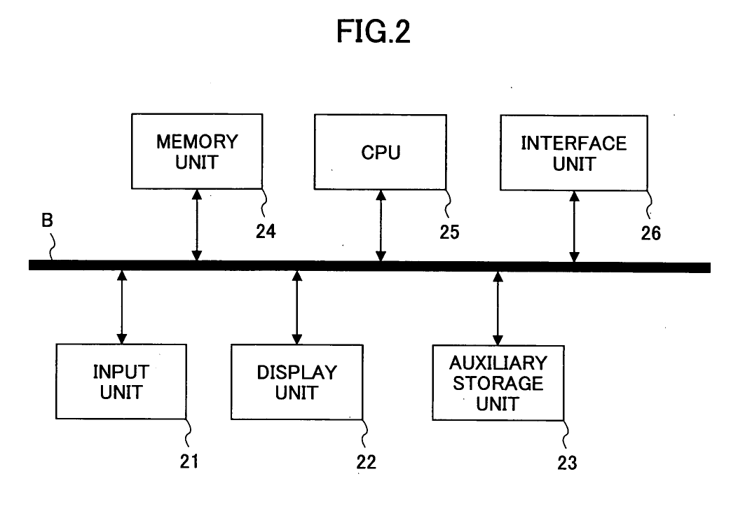

Next, a hardware configuration of the information processing apparatus 1 will be described. FIG. 2 is a block diagram showing the hardware configuration of the information processing apparatus according to the present invention. In FIG. 2, the information processing apparatus 1 includes an input unit 21, a display unit 22, an auxiliary storage unit 23, a memory unit 23, a CPU (Computer Processing Unit) 25 and an interface unit 26, which are mutually connected via a bus B.

The input unit 21 includes a keyboard, a mouse, a like, and is used to input various operation instructions. The display unit 22 displays various windows, data, and a like needed for a user to operate. The interface unit 26 is an interface for connecting the information processing apparatus 1 to the network, and includes a modem, a router, and a like.

The auxiliary storage unit 23 stores programs causing the information processing apparatus 1 to conduct processes according to the information processing apparatus, and also stores various files, data, and a like needed for the programs to conduct the processes. The memory unit 24 reads out and stores the programs from the auxiliary storage unit 23 when the information processing apparatus 1 is booted. The CPU 25 executes the processes in accordance with the programs stored in the memory unit 24.

Next, an image forming apparatus as a variation of the information processing apparatus 1 will be described. The image forming apparatus is called a multi-functional apparatus since various functions serves as a printer, a copier, a facsimile, a scanner, and a like are accommodated in a single body of the image forming apparatus.

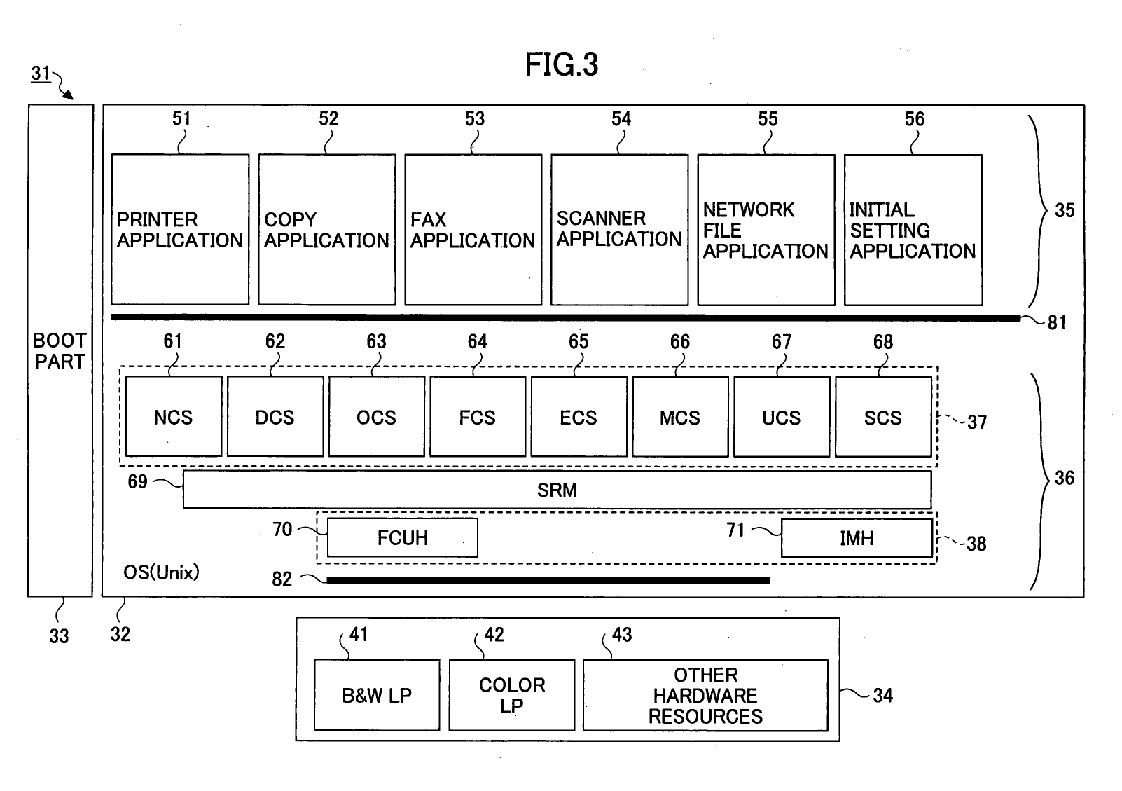

FIG. 3 is a block diagram showing a functional configuration of the multi-functional apparatus according to the present invention. The multi-functional apparatus 31 includes a software group 32, a boot part 33, and hardware resources 34. The boot part 33 is activated first when the multi-functional apparatus 31 is turned on, and activates an application layer 35 and a platform 36. The hardware resources 34 includes a white and black laser printer (B & W LP) 41, a color laser printer (Color LP) 42, and other hardware resources 43 such as a scanner, a facsimile, and a like. The software group 32 includes the application layer 35 and the platform 36, which are activated on an OS (Operating System) such as UNIX™.

The application layer 35 includes a printer application 51, a copy application 52, a fax application 53, a scanner application 54, and a network file application 55, and an initial setting application 56. The network file application 55 is an application for a network file, and manages a communication with the information storing server, and the like connected to the multi-functional apparatus 31 through the network.

The platform 36 includes a control service layer 37 that reads a process request received from the application layer 35 and issues an acquisition request to the hardware resources 34, an SRM (System Resource Manager) 69 that manages the hardware resources 34 and mediates a plurality of acquisition requests received from the control service layer 37, and a handler layer 38 that manages the hardware resources 34 in response to the acquisition request from the SRM 69.

The control service layer 37 includes at least one of an NCS (Network Control Service) 61, a DSC (Delivery Control Service) 62, an OCS (Operation panel Control Service) 63, an FCS (Facsimile Control Service) 64, an ECS (Engine Control Service) 65, an MCS (Memory Control Service) 66, an UCS (User information Control Service) 67, an SCS (System Control Service) 68, and a like as service modules.

The platform 36 is configured so as to include an API (Application Program Interface) 81. The OS executes the software of the application layer 35 and the platform 36 as a process.

A process of the NCS 61 mediates sending and receiving data. A process of the DCS 62 controls a delivery of document data accumulated in the multi-functional apparatus 31. A process of the OCS 63 controls an operation panel which is used to communicate between an operator and the multi-functional apparatus 31. A process of the FCS 64 provides an interface to send and receive data as a facsimile function. A process of the ECS 65 controls an engine part of the hardware resources 34. A process of the MCS 66 conducts a memory control. A process of the UCS 67 manages the user information. A process of the SCS 68 conducts a process for controlling a system. A process of the SRM 69 controls the system and manages the hardware resources 34 with the SCS 68.

The handler layer 38 includes an FCUH (Facsimile Control Unit Handler) 70 which manages an FCU (Facsimile Control Unit), which will be described later, and an IMH (Image Memory Handler) 71 which assigns a memory area for each process and manages the memory area assigned to each process. The SRM 69 and the FCUH 70 conducts the process request to the hardware resources 34 by utilizing an engine I/F 82. By applying the functional configuration, the multi-functional apparatus 31 can centralize and conduct processes needed in common for all applications in the platform 36.

The UCS 67 corresponds to a connection information managing part in claims. The facsimile application 53, the scanner application 54, the network file application 55, the initial setting application 56, and the SCS 68 correspond to a request part in claims.

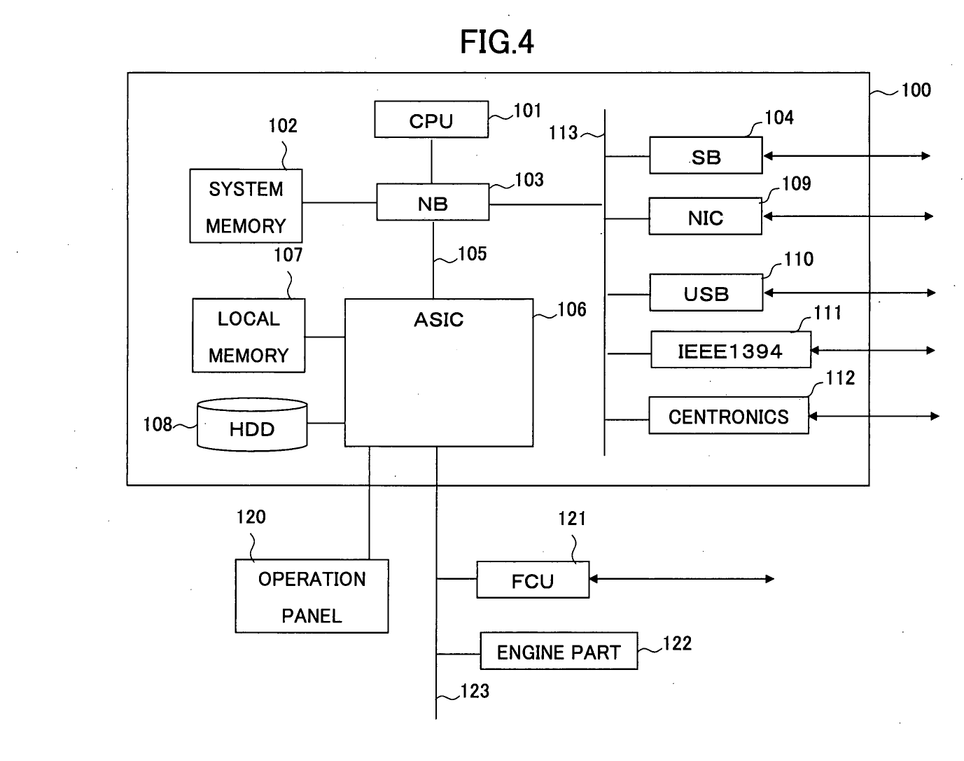

Next, a hardware configuration of the multi-functional apparatus 31 will be described. FIG. 4 is a block diagram showing the hardware configuration according to the present invention. The multi-functional apparatus 31 includes a controller 100, an operation panel 120, an FCU 121, and an engine part 122. The controller 100 includes a CPU 101, a system memory 102, an NB (North Bridge) 103, an SB (South Bridge) 104, an ASIC 106, a local memory 107, an HDD (Hard Disk Device) 108, an NIC (Network Interface Card) 109, an USB (Universal Serial Bus) device 110, an IEEE 1394 device 111, and a centronics 112.

The CPU 101 controls the entire multi-functional apparatus 31. For example, the CPU 101 activates and conducts a process on the OS. The NB 103 is a bridge. The SB 104 is a bridge to connect a PCI (Peripheral Component Interconnect) bus 113 to a ROM (Read-Only Memory), peripheral devices, and a like. The system memory 102 is a memory used to form an image in the multi-functional apparatus 31. The local memory 107 is a memory used as an image buffer for a copy, and a code buffer.

The ASIC 106 is an IC including hardware elements for an image process. The HDD 108 is used as a storage (auxiliary storage unit) which accumulates image data, document data, programs, font data, and a like. The NIC 109 is an interface device to connect the multi-functional apparatus 31 to the network. The USB device 110, the IEEE 1394 device 111, and the centronics 112 are interfaces according to respective standards.

The operation panel 120 receives an input operation from the operator, and is an operation part to display information for the operator. The FCU 121 includes a memory to temporarily store facsimile data when the multi-functional apparatus 31 is turned off.

In the following, processes of the multi-functional apparatus 31 as the variation of the information processing apparatus 1 according to the present invention will be described. In this case, the information storing server is compliant with the LDAP, is called an LDAP server, and the connection information for connecting to the information storing server is called LDAP server information. Also, the user information is managed as a part of various information managed by the LDAP server.

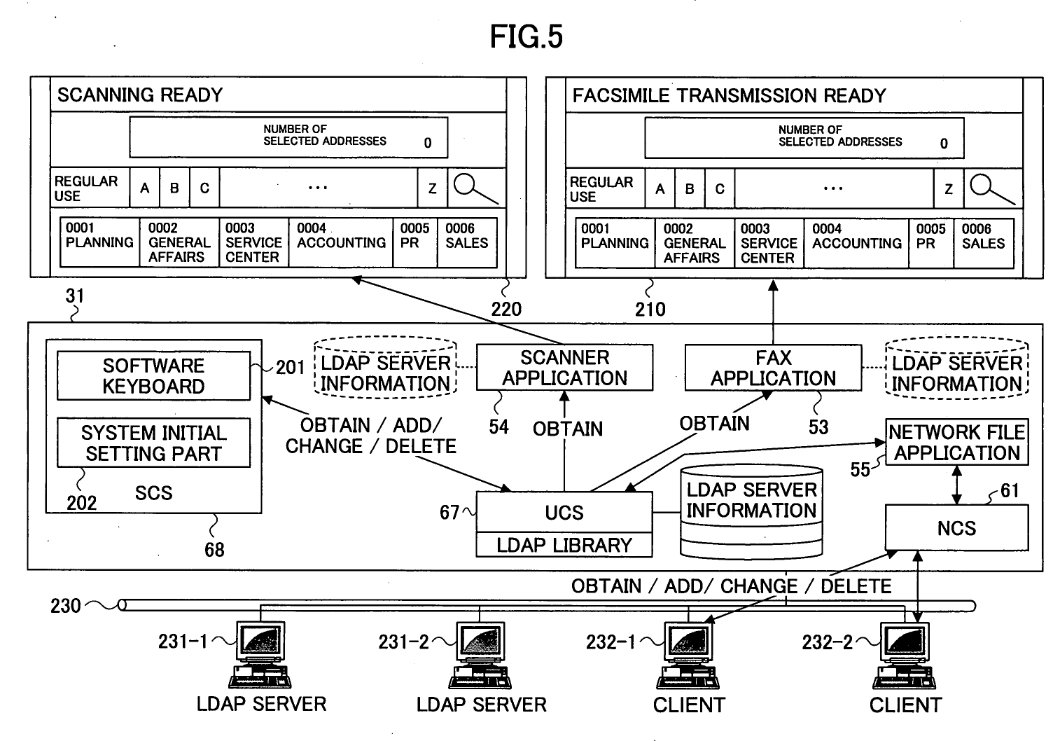

FIG. 5 is a diagram for explaining an obtain request, an add request, a change request, and a delete request of the LDAP server according to the present invention. In FIG. 5, configuration parts, which are not required to explain, are omitted. For example, the UCS 67 stores and manages the LDAP server information in the HDD 108. The LDAP server information includes a server ID, a server name, an host name (IP address), a port number, a search start position, an authentication information, an arbitral search condition (multiple conditions), a character code, and a like as items.

The UCS 67 provides the LDAP server information to the fax application 53, the scanner application 54, the network file application 55, the SCS 68, and clients 232-1 and 232-2 in response to the obtain request from the fax application 53, the scanner application 54, the SCS 68, and the clients 232-1 and 232-2 from outside the multi-functional apparatus 31. The UCS 67 adds, changes, or deletes the LDAP server information in response to an add request, a change request, or a delete request from the SCS 68 and the clients 232-1 and 232-2.

The fax application 53 sends the obtain request of the LDAP server information to the UCS 67 to obtain the LDAP server information. The fax application 53 obtains the user information needed for the fax function by using the LDAP server information as described later, and displays a screen 210 at the operation panel 110 by using the user information.

The scanner application 54 obtains the LDAP server information by sending the obtain request of the LDAP server information to the UCS 67. The scanner application 54 obtains the user information needed for the scanner function by using the LDAP server information as described later, and displays a screen 220 at the operation panel 110 by using the user information. The screen 220 displays information for the operator to select destination information (for example, an electronic mail address) needed to send scanner data.

A system initial setting function 202 of the SCS 68 obtains, adds, changes, and deletes the LDAP server information by sending the obtain request, the add request, the change request, and the delete request to the UCS 67. A software keyboard function 201 of the SCS 38 displays a software keyboard at the operation panel 70, and controls the software keyboard. The clients 232-1 and 232-2 obtains, adds, changes, and deletes the LDAP server information by sending the obtain request, the add request, the change request, the delete request of the LDAP server information through the NCS 61 and the network file application 55.

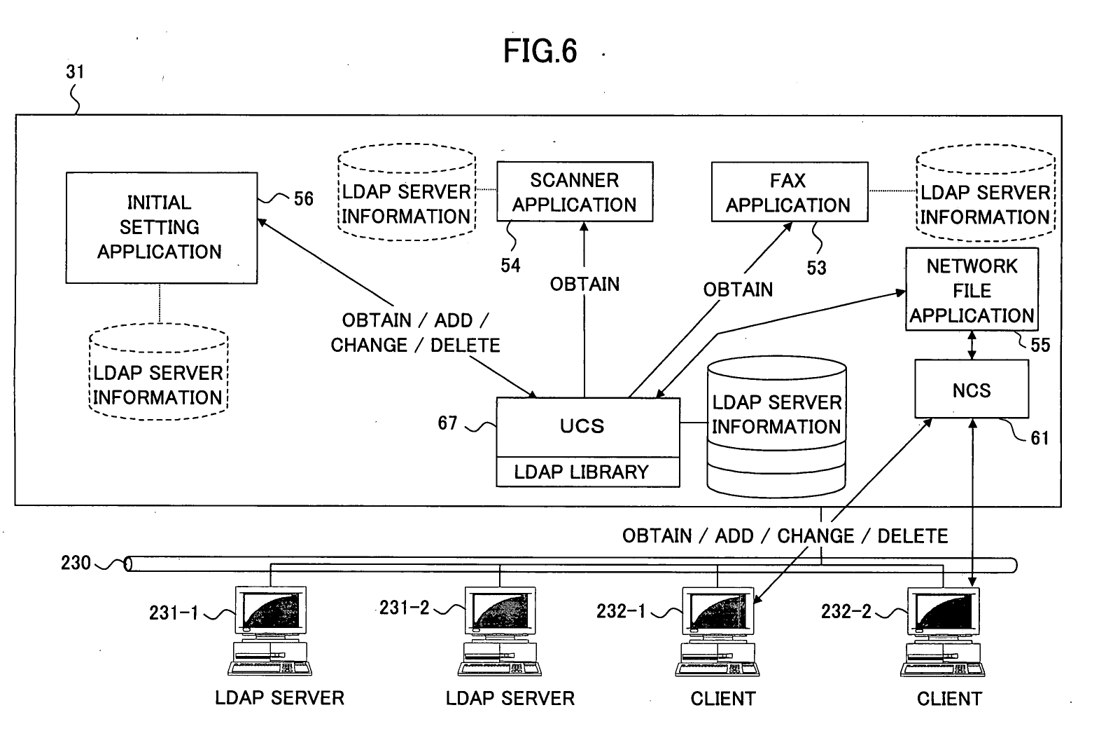

Alternatively, the initial setting application 56 having the same function as the system initial setting function 202 of the SCS 68 as shown in FIG. 6 may send the obtain request, the add request, the change request, and the delete request of the LDAP server information. FIG. 6 is a diagram for explaining the obtain request, the add request, the change request, and the delete request of the LDAP server according to the present invention. In FIG. 6, different from FIG. 5, instead of the system initial setting function 202 of the SCS 68, the initial setting application 56 sends the obtain request, the add request, the change request, and the delete request of the LDAP server information.

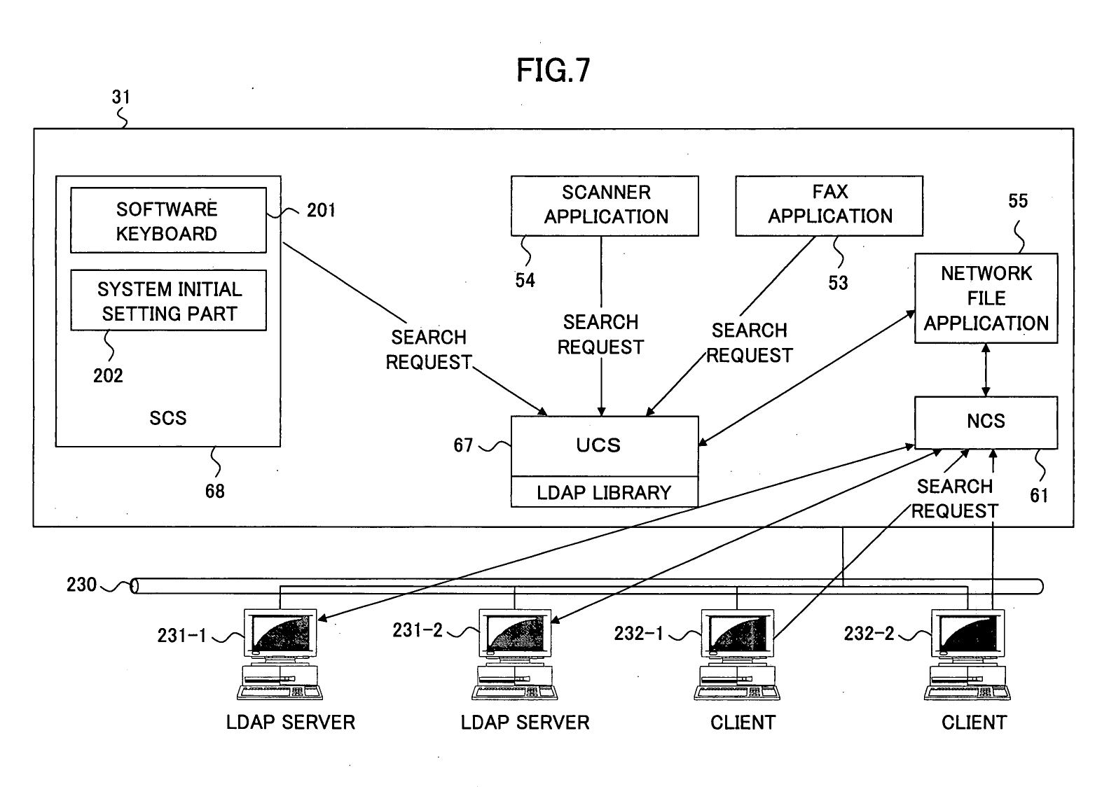

FIG. 7 is a diagram for explaining a search request of the LDAP server information according to the present invention. In FIG. 7, configuration elements, which are not necessary in this explanation, are omitted. The UCS 67 sends the search request to the LDAP servers 231-1 and 231-2 in response to the search request and search information as described later sent from the fax application 53, the scanner application 54, the SCS 68, or the clients 232-1 and 232-2. The UCS 67 sends the search request to the LDAP server 231-1 and 231-2 through the network file application 55, the NCS 61, and a network 230.

The UCS 67 receives a search response with respect to the search request, from the LDAP servers 231-1 and 231-2 through the NCS 61 and the network file application 55. When the UCS 67 receives the search response, the UCS 67 sends the search response to the fax application 53, the scanner application 54, the SCS 68, or the clients 232-1 and 232-2.

The fax application 53 sends the search request of the user information necessary for the fax function by using the LDAP server information, and searches for the user information stored in the LDAP servers 231-1 and 231-2. When the fax application 53 sends the search request of the user information to the UCS 67, the fax application 53 sends search subject server information such as a server ID, a server name, an host name, a port number, and a like, and also the search information necessary for a search such as a search condition, a maximum hit number, and a like, with the search information.

Similar to the fax application 53, the scanner application 54 sends the search request of the user information necessary for the fax function by using the LDAP server, and searches for the user information stored in the LDAP servers 231-1 and 231-2. When the scanner application 54 sends the search request of the user information to the UCS 67, the scanner application 54 sends the search information to the UCS 67 with the search request.

The system initial setting function 202 of the SCS 68 sends the search request of the user information to the UCS 67 b using the LDAP server information, and searches for the user information stored in the LDAP servers 231-1 and 231-2. When the system initial setting function 202 of the SCS 68 sends the search request of the user information to the UCS 67, the system initial setting function 202 sends the search information to the UCS 67 with the search request.

The clients 232-1 and 232-2 searches for the user information stored in the LDAP servers 231-1 and 231-2 by sending the search request of the user information by using the LDAP server information. When the clients 232-1 and 232-2 sends the search request of the user information to the UCS 67, the clients 232-1 and 232-2 sends the search information to the UCS 67 with the search request.

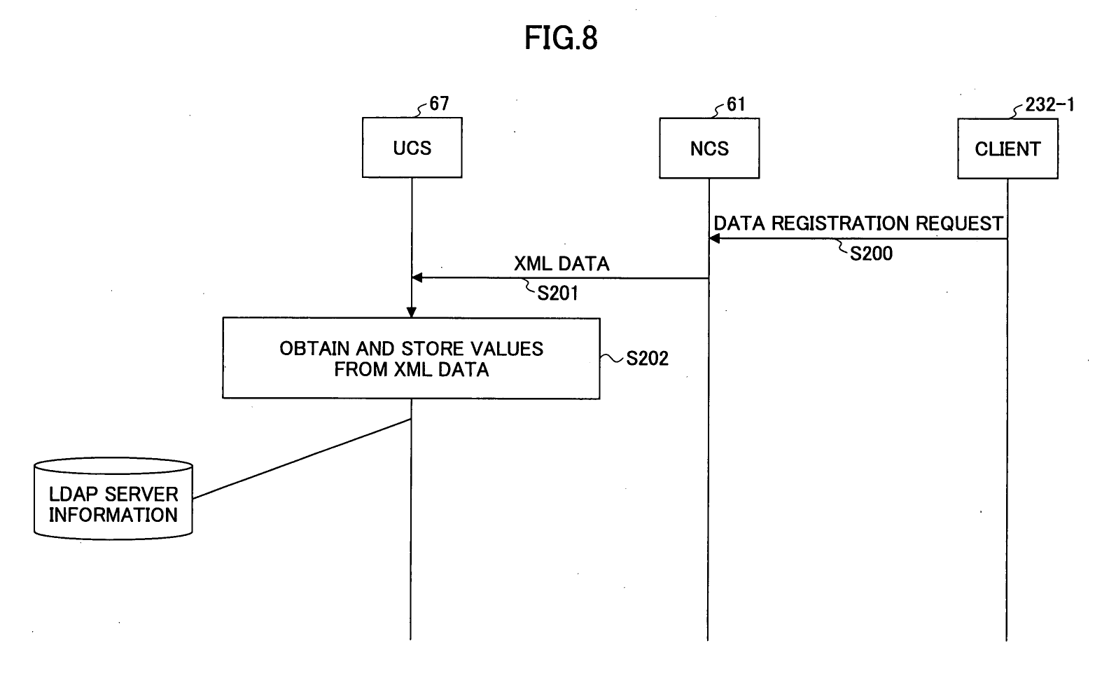

When the clients 232-1 and 232-2 send the obtain request, the add request, the change request, the delete request, or the search request, for example, an XML (Extensible Marckup Language) is used. A registration process for the clients 232-1 and 232-2 to register the LDAP server information to the UCS 67 will be described with reference to FIG. 8.

FIG. 8 is a sequence diagram showing the registration process for registering the LDAP server information by an instruction conducted at a screen of the clients 232-1 according to the present invention. In step S200, a user instructs to display an LDAP server information registration screen by operating the client 232-1. In response to the instruction of the user, the client 232-1 displays the LDAP server information registration screen. The user operates the client 232-1 and registers the LDAP server information at the LDAP server information registration screen displayed at the client 232-1.

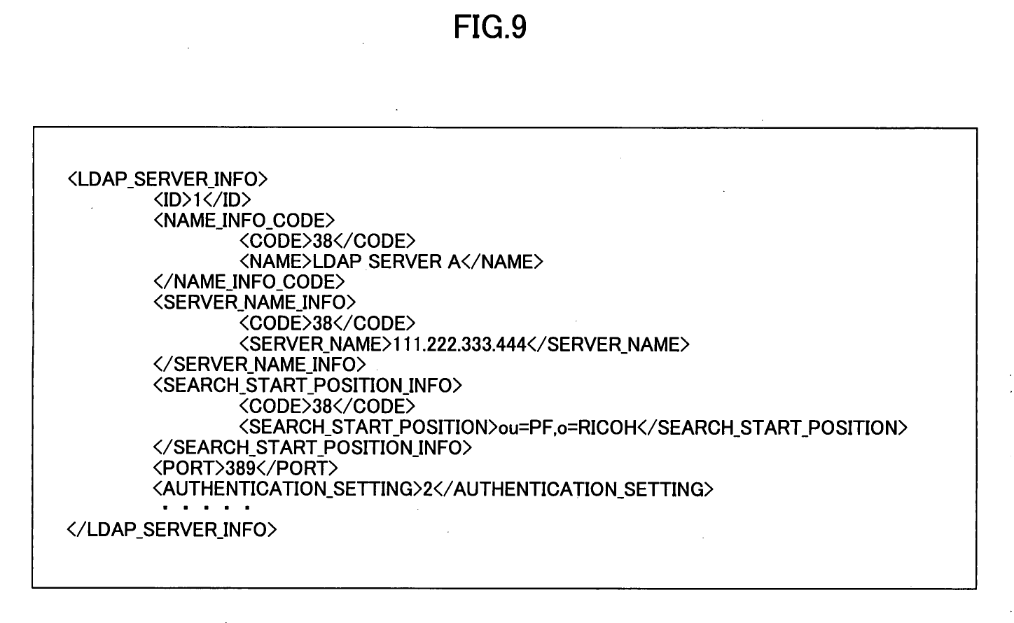

The client 232-1 sends a data registration request of the lDAP server information which the user registers at the LDAP server information registration screen. When the registration process advances to step S201, for example, the NCS 61 retrieves XML data included in the data registration request received from the client 232-1 as shown in FIG. 9, and supplies the XML data to the UCS 67. The registration process advances to step S202. The UCS 67 retrieves the LDAP server information from the XML data supplied from the NCS 61, and stores to the HDD 108.

As described above, the clients 232-1 and 232-2 send the obtain request, the add request, the change request, the delete request, or the search request to the multi-functional apparatus by utilizing the XML. Next, processes utilizing the obtain request, the add request, the change request, the delete request, and the search request will be described with reference to sequence diagrams, respectively.

[First Embodiment]

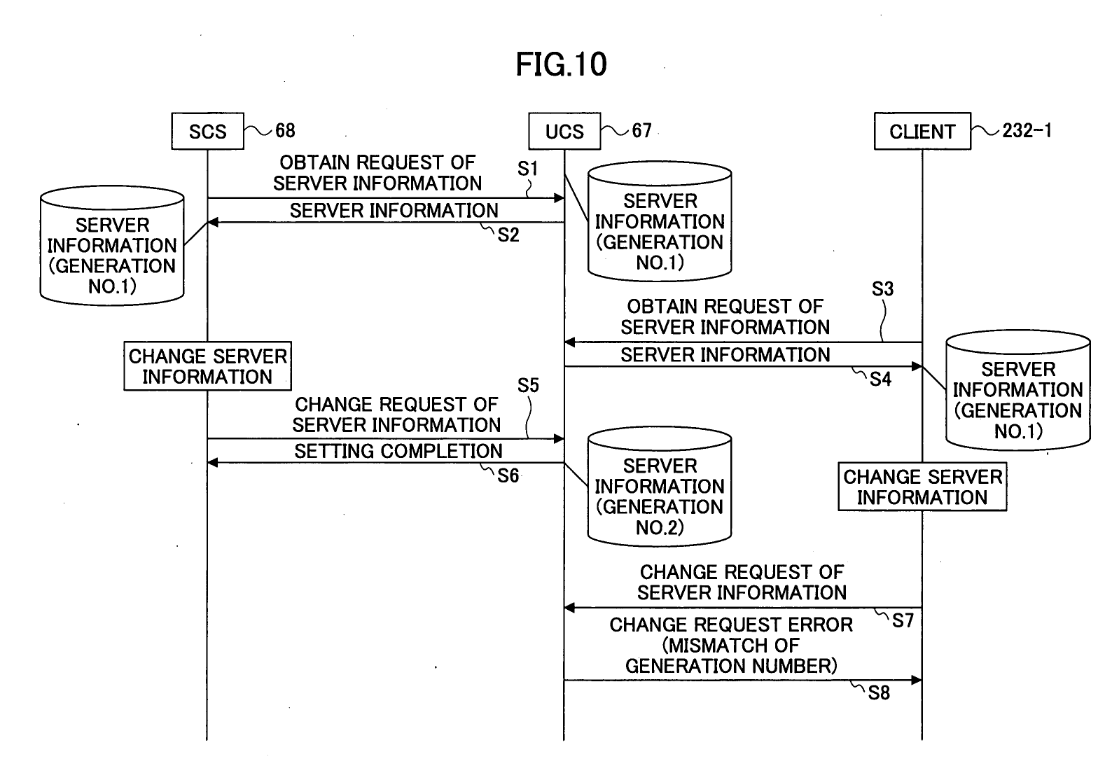

FIG. 10 is a sequence diagram for explaining a process for changing the LDAP server information according to a first embodiment of the present invention. The LDAP server information is associated with a generation number which is incremented by one generation for each update, and is configured so as to include generation number information indicating the generation number. In the following, the LDAP server information which a generation number n is associated with is called the LDAP server information of the generation number n.

In step S1, the SCS 68 sends an obtain request of the LDAP server information with respect to the UCS 67. In response to the SCS 68, the UCS 67 reads out the LDAP server information from the HDD 108. In this case, the LDAP server information of a generation number 1 is read out. In step S2, the UCS 67 provides the LDAP server information of the generation number 1 to the SCS 68. After the step S2, the SCS 68 changes the LDAP server information in response to an instruction from the operator.

In addition, in step S3, for example, the client 232-1 sends an obtain request of the LDAP server information to the UCS 67. In response to the obtain request from the client 232-1, the UCS 67 reads out the LDAP server information. In this case, the LDAP server information of the generation number 1 is read out. In step S4 following to the step S3, the UCS 67 provides the LDAP server information of the generation number 1 to the client 232-1. After the step S4, the client 232-1 changes the LDAP server information in accordance with the instruction of the operator.

In the step S5, based on the LDAP server information changed by the instruction from the operator, the SCS 68 sends a change request of the LDAP server information to the UCS 67. When the UCS 67 receives the change request from the SCS 68, the UCS 67 compares the generation number 1 included in the change request with the generation number 1 of the LDAP server information stored and managed in the HDD 108 or the like.

In this case, since both the generation numbers are the same each other, the UCS 67 changes the LDAP server information in reseponse to the change request from the SCS 68, and changes the generation number from “1” to “2”. In step S6 following to the step S5, the UCS 67 sends a setting completion of the LDAP server information to the SCS 68.

In step S7, based on the LDAP server information changed by the instruction from the operator, the client 232-1 sends the change request of the LDAP server information with respect to the UCS 67. It should be noted that the change request of the LDAP server information includes the generation number 1. When the UCS 67 receives the change request from the client 232-1, the UCS 67 compares the generation number 1 included in the change request with the generation number 2 of the LDAP server information stored and managed in the HDD 108 or the like.

In this case, since both generation numbers are different each other, the UCS 67 changes the LDAP server information in response to the change request from the client 232-1. On the other hand, if both generation numbers are the same each other, the UCS 67 changes the LDAP server information in response to the change request from the clinet 232-1.

Subsequently, in step S8 following to the step S7, the UCS 67 informs a change request error caused by a mismatch of the generation numbers to the client 232-1. However, the client 232-1 can change the LDAP server information by repeating a process from the obtain request of the LDAP server information.

In the sequence diagram of FIG. 10, by changing the LDAP server information by the change request only if both generation numbers are the same each other, it is possible to maintain consistency of the LDAP server information even if another request is redundantly conducted. As a result, it is possible to maintain the consistency of the LDAP server information without an exclusive access control for a transaction with respect to the LDAP server information in the sequence diagram of FIG. 10.

In another manner, the UCS 67 may change the LDAP server information in response to the change request, even if the generation number included in the request number and the generation number of the LDAP server information stored and managed in the HDD 108 or the like are different each other.

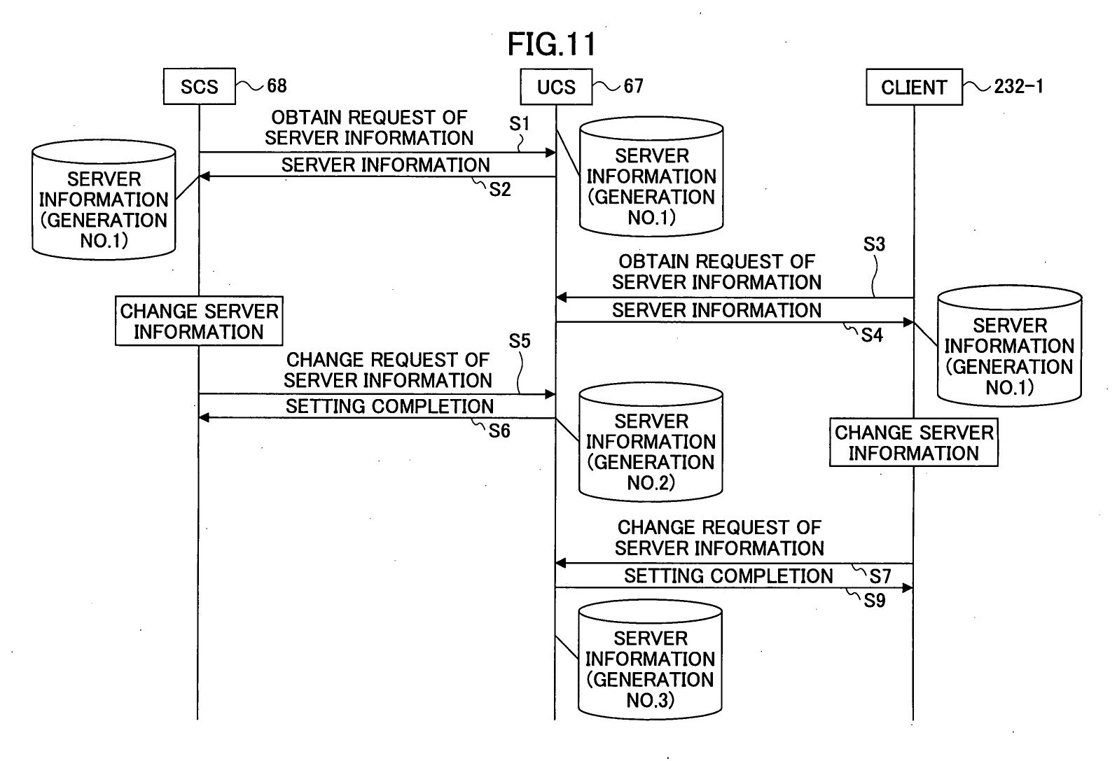

FIG. 11 is a sequence diagram for explaining another process for changing the LDAP server information according to the first embodiment of the present invention. The sequence diagram of FIG. 11 is the same as that of FIG. 10 except for a part of the sequence diagram of FIG. 11. The steps S1 through S6 in FIG. 11 are the same as the ones in FIG. 10 and the explanation thereof will be omitted.

In step S7, based on the LDAP server information changed by the instruction from the operator, the client 232-1 sends the change request of the LDAP server information with respect to the UCS 67. The change request of the LDAP server information includes the generation number 1. When the UCS 67 receives the change request from the client 232-1, the UCS 67 compares the generation number 1 included in the change request with the generation number 2 of the LDAP server information stored and managed in the HDD 108.

In this case, although both generation numbers are different each other, the UCS 67 changes the LDAP server information in response to the change request from the SCS 68, and changes the generation number to “3”. Then, in step S9 following to the step S7, the UCS 67 sends the setting completion of the LDAP server information. When the UCS 67 sends the setting completion to the SCS 68 in the step S9, the UCS 67 may include information showing a mismatch of the generation number in the setting completion to display the information showing the mismatch of the generation number at the client 232-1.

In the sequence diagram of FIG. 11, by changing the LDAP server information even if both generation numbers are different each other, it is possible to change the LDAP server information without repeating the process from the obtain request of the LDAP server information. The process shown in the sequence diagram of FIG. 11 is effective in a case in that there is no problem even if the consistency of the LDAP server information is not maintained.

[Second Embodiment]

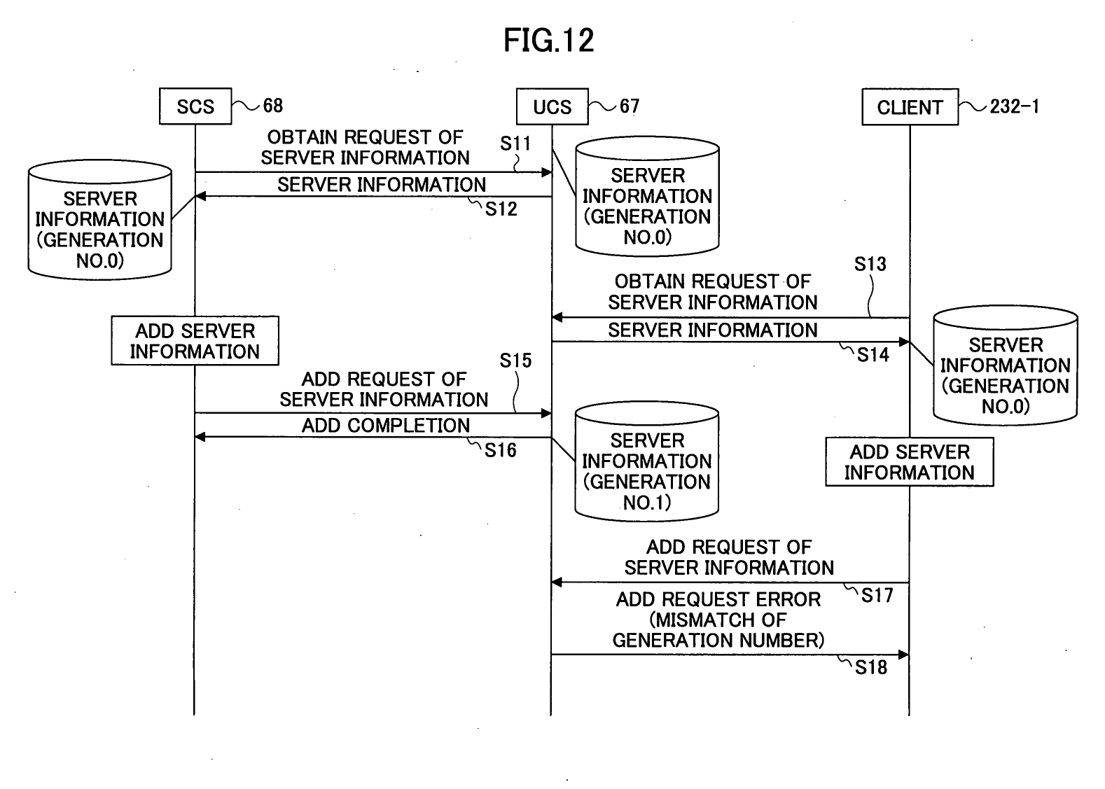

FIG. 12 is a sequence diagram for explaining a process for adding the LDAP server information according to a second embodiment of the present invention. In this case, the LDAP server information includes generation number information showing the generation number. In step S1, the SCS 68 sends an obtain request of the LDAP server information to the UCS 67. The UCS 67 reads out the lDAP server information from the HDD 108 or the like in response to the obtain request from the SCS 68. In this case, the LDAP server information of the generation number 0 is read out. The LDAP server information of the genration number 0 shows the LDAP server information as a new registration. In step S12 following to the step S1, the UCS 67 provides the LDAP server information of the generation number 0 read our from the HDD 108 or the like to the SCS 68. After the step S12, the SCS 68 changes the LDAP server information by the instruction from the operator.

In step S13, for example, the client 232-1 sends the LDAP server information to the UCS 67. The UCS 67 reads out the LDAP server information in response to the obtain request from the client 232-1. In this case, the LDAP server information of the generation number 0 is read out. In step S14 following to the step S13, the UCS 67 provides the LDAP server information of the generation number 0 read out in the step S13 to the client 232-1. After the step S14, the client 232-1 changes the LDAP server information by the instruction from the operator.

In step S15, based on the LDAP server information changed by the instruction from the operator, the SCS 68 sends an add request of the LDAP server information to the UCS 67. The addd request of the LDAP server information includes the generation number 0. When the UCS 67 receives the add request from SCS 68, the UCS 67 compares the generatioin number 0 included in the add request with the generation number 0 of the LDAP server information stored and managed in the HDD 108 or the like. In this case, since both generation numbers are the same each other, the UCS 67 adds the LDAP server information in response to the add request from the SCS 68, and changes the generation number to be “1”. In step S16 following to the step S15, the UCS 67 sends the setting completion of the LDAP server information to the SCS 68.

In step S17, based on the LDAP server information added by the instruction from the operator, the lient 232-1 sends the add request of the LDAP server information to the UCS 67. The add request of the LDAP server information includes the generation number 0. When the UCS 67 receives the add request from the client 232-1, the UCS 67 compares the generation number 0 included in the add request with the generation number 1 of the LDAP server information stored and managed in the HDD 108 or the like.

In this case, since both generation numbers are different each other, the UCS 67 dose not add the LDAP server information in response to the add request from the SCS 68. On the other hand, if both generation numbers are the same each other, the UCS 67 adds the LDAP server information in response to the add request from the SCS 68. Then, in step S18 following to the step S17, the UCS 67 informs an add request error caused by a mismatch of the generation number to the client 232-1. However, the client 232-1 can add the LDAP server information by repeating the process from the obtain request of the LDAP server information.

In the sequence diagram of FIG. 12, by adding the LDAP server information by the add request only if both generation numbers are the same each other, it is possible to maintain the consistency of the LDAP server information even if another request is redundantly conducted. As a result, in the sequence diagram of FIG. 12, it is possible to maintain the consistency of the LDAP server information without an exclusive access control for the transaction with respect to the LDAP server information.

On the other hand, even if the generation number included in the add request is different from the generation number of the LDAP server stored and managed in the HDD 108 or the like, the UCS 67 may add the LDAP server information in response to the add request.

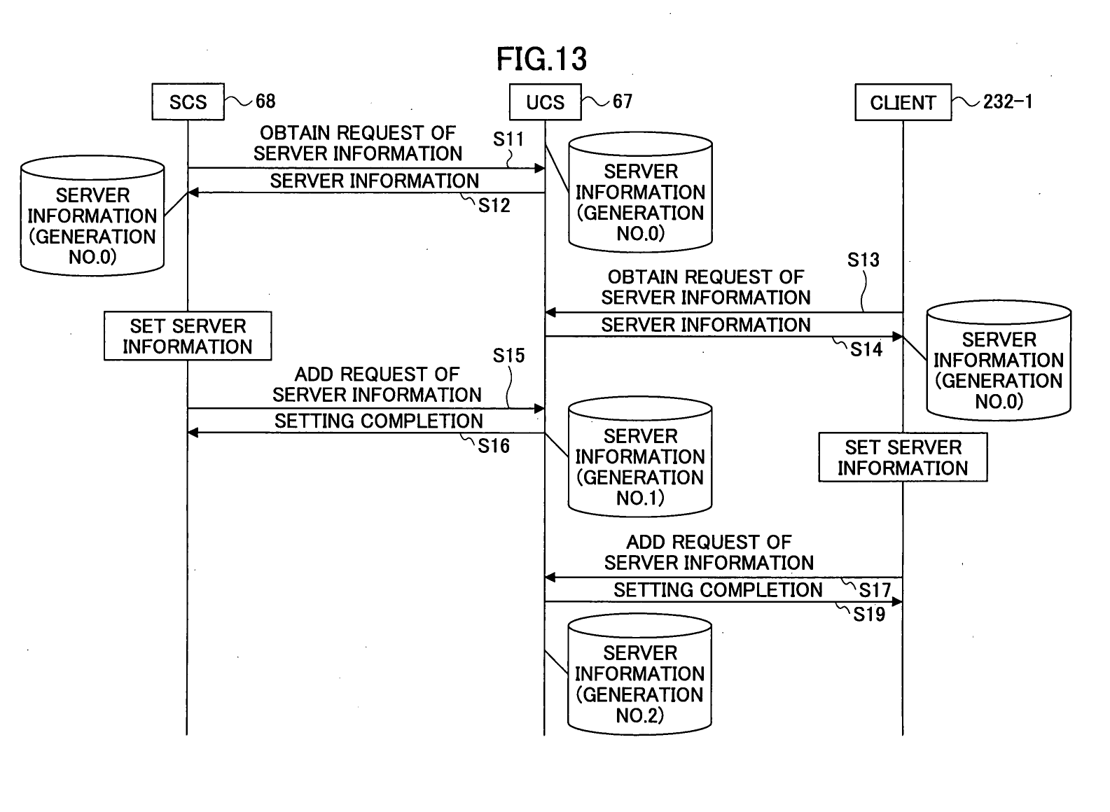

FIG. 13 is a sequence diagram for explaining another process for adding the LDAP server information according to the second embodiment of the present invention. The sequence diagram of FIG. 13 is the same as that of FIG. 12 except for a part of the sequence diagram of FIG. 13. The steps S11 through S17 in FIG. 13 are the same as the ones in FIG. 12 and the explanation thereof will be omitted.

In step S17, based on the LDAP server information added by the instruction from the operator, the client 232-1 sends the add request of the LDAP server information to the UCS 67. In this case, the add request of the LDAP server information includes the generation number 0. When the UCS 67 receives the add request from the client 232-1, the UCS 67 compares the generation number 0 included in the add request with the generation number 1 of the LDAP server information stored and manated in the HDD 108 or the like.

In this case, although both generation numbers are different each other, the UCS 67 adds the LDAP server information in response to the add request from the SCS 68 and changes the generation number to be “2”. Subsequently, in step S19 following to the step S17, the UCS 67 sends the setting completion of the LDAP server information to the SCS 68. For example, when the UCS 67 sends the setting completion to the SCS 68 in the step S19, the UCS 67 may include information showing the mismatch of the generation number, so as to display the information showing the mismatch of the generation number at the client 232-1.

In the sequence diagram of FIG. 13, by adding the LDAP server information even if both generation numbers are not the same each other, it is possible to add the LDAP server information by repeating the process from the obtain request of the LDAP server information. The process shown in the sequence diagram of FIG. 13 is effective in a case in that there is no problem even if the consistency of the LDAP server information is not maintained.

[Third Embodiment]

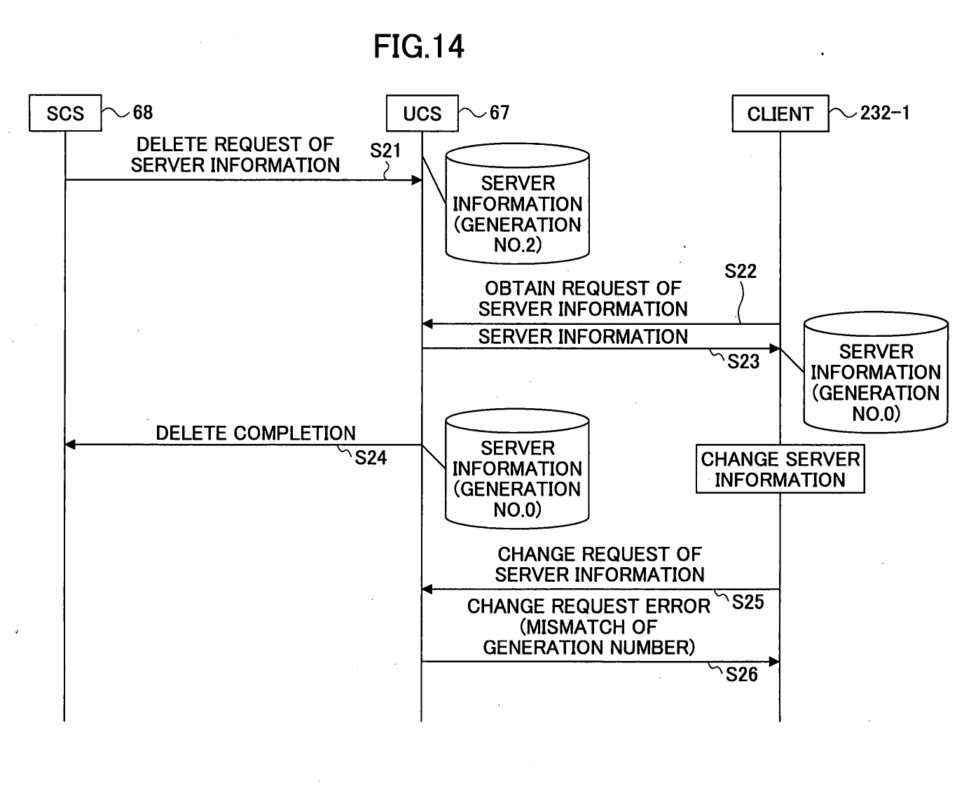

FIG. 14 is a sequence diagram for explaining a process for deleting the LDAP server information according to a third embodiment of the present invention. In this case, the LDAP server information shown in FIG. 9 includes generation number information showing the generation number.

In step S21, the SCS 68 sends a delete request of the LDAP server information to the UCS 67. The UCS 67 starts a delete process of the LDAP server information in response to the delete request from the SCS 68.

In step S22, for example, the client 232-1 sends the obtain request of the LDAP server information to the UCS 67. The UCS 67 reads out the LDAP server information in response to the obtain request from the client 232-1. In this case, the LDAP server information of the generation number 2 is read outs. In step S23 following to the step S22, the UCS 67 provides the LDAP server information of the generation number 2 read out in the step S22. After the step S23, the client 232-1 changes the LDAP server information by an instruction from the operator.

In step S24, when the delete process of the LDAP server information corresponding to the delete request in the step S21 is completed, and the generation number of the LDAP server information is changed. In this case, the LDAP server information is reset to show default values. Then, the UCS 67 sends a delete completion of the LDAP server information to the SCS 68.

In step S25, based on the LDAP server information changed by the instruction from the operator, the client 232-1 sends a change request of the LDAP server to the UCS 67. In this case, the change request of the LDAP server information includes the generation number 2. When the UCS 67 receives the change request from the client 232-1, the UCS 67 compares the generation number 2 included in the change request with the generation number 0 of the LDAP server information stored and managed in the HDD 108 or the like. In this case, since both generation numbers are different each other, the UCS 67 does not change the LDAP server information in response to the change request from the client 232-1. On the other hand, if both generation numbers are the same each other, the UCS 67 changes the LDAP server information in response to the change request from the clinet 232-1.

Subsequently, in step S26 following to the step S25, the UCS 67 informs a change request error caused by a mismatch of the generation number to the client 232-1. However, the client 232-1 can change the LDAP server information by repeating the process from the obtain request of the LDAP server information.

In the sequence diagram of FIG. 14, by changing the LDAP server information by the change request only if both generation numbers are the same each other, it is possible to maintain the consistency of the LDAP server information even if another request is redundantly conducted. As a result, in the sequence diagram of FIG. 14, it is possible to maintain the consistency of the LDAP server information without an exclusive access control for the transaction with respect to the LDAP server information.

In another manner, the UCS 67 may change the LDAP server information in response to the change request, even if the generation number included in the request number and the generation number of the LDAP server information stored and managed in the HDD 108 or the like are different each other.

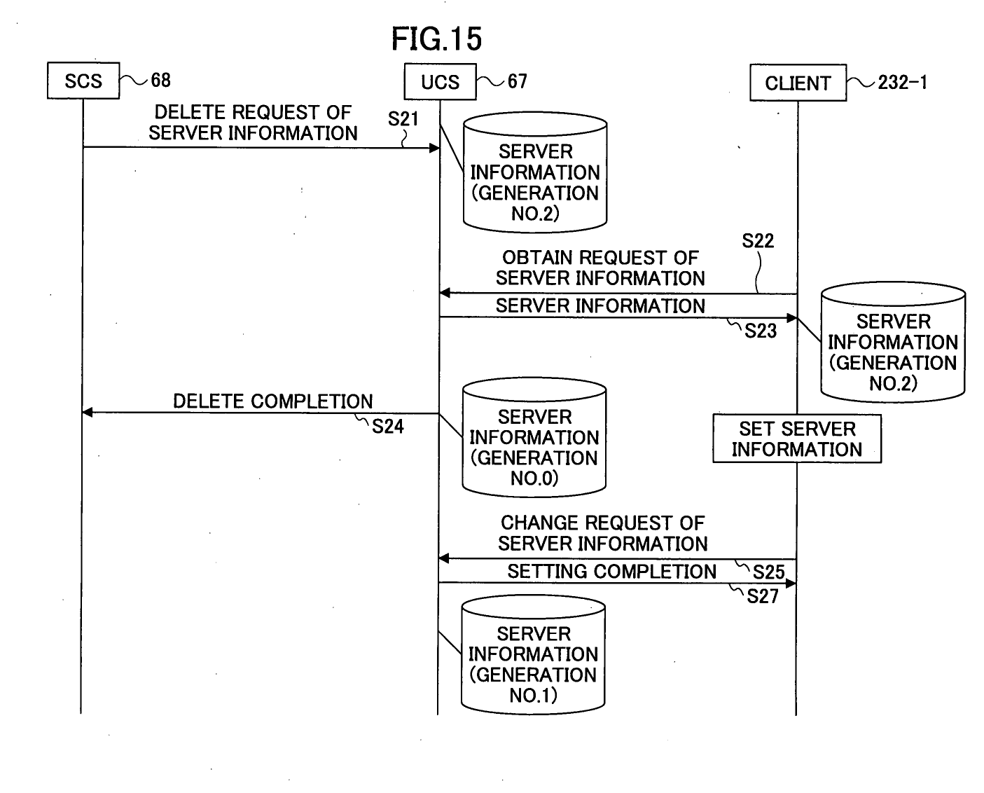

FIG. 15 is a sequence diagram for explaining another process for deleting the LDAP server information according to the third embodiment of the present invention. The sequence diagram of FIG. 15 is the same as that of FIG. 14 except for a part of the sequence diagram of FIG. 15. The steps S21 through S24 in FIG. 15 are the same as the ones in FIG. 14 and the explanation thereof will be omitted.

In step S25, based on the LDAP server information changed by the instruction of the operator, the client 232-1 sends the change request of the LDAP server information to the UCS 67. In this case, the change request of the LDAP server information includes the generation number 2. When the UCS receives the change request from the client 232-1, the UCS 67 compares the generation number 2 included in the change request with the generation number 0 of the LDAP server information stored and managed in the HDD 108 or the like.

In this case, although both generation numbers are different each other, the UCS 67 changes the LDAP server information in response to the change request from the SCS 68, and changes the generation number to be “1”. Then, in step S27 following to the step S25, the UCS 67 sends the setting completion of the LDAP server information to the SCS 68. When the UCS 67 sends the setting completion to the SCS 68 in the step S27, for example, the UCS 67 may include information showing a mismatch of the generation number, so as to display the information showing a mismatch of the generation number at the client 232-1.

In the sequence diagram of FIG. 15, by changing the LDAP server information by the change request even if both generation numbers are not the same each other, it is possible to change the LDAP server information without repeating the process form the obtain request of the LDAP server information. The process shown in the sequence diagram of FIG. 15 is effective in a case in that there is no problem even if the consistency of the LDAP server information is not maintained.

[Fourth Embodiment]

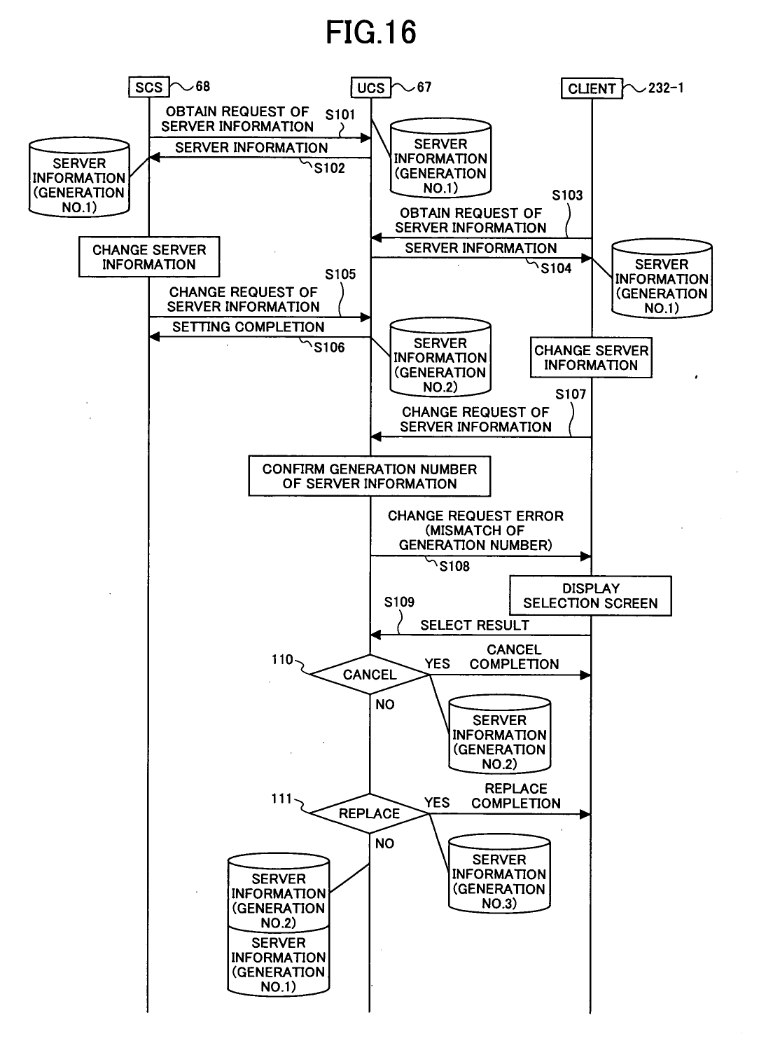

In the processes shown in the sequence diagrams shown in FIG. 11, FIG. 13, and FIG. 15, the processes corresponding to the obtain request, the add request, the change request, the delete request, and the search request are conducted without a confirmation of the operator. Alternatively, the operator may be allowed to select the following process. In a case in that both generation numbers of the LDAP server information are different each other, an operation for the operator to select the following process is conducted in the same manner. Thus, a process corresponding to the change request will be described. FIG. 16 is a sequence diagram for explaining a process for the operator to select the following process in a case in that both generation numbers of the LDAP server information are different each other, according to a fourth embodiment of the present invention.

In step S101, the SCS 68 sends an obtain request of the LDAP server information to the UCS 67. In step S102, the UCS 67 reads out and provides the LDAP server information of the generation number 1 to the SCS 68. After the step S102, the SCS 68 changes the LDAP server information by an instruction of the operator.

In step S103, for example, the client 232-1 sends an obtain request of the LDAP server information with respect to the UCS 67. In step S104, the UCS 67 reads out and provides the LDAP server information of the generation number 1 to the client 232-1. After the step S104, the client 232-1 changes the LDAP server information by the instruction of the operator.

In step S105, based on the LDAP server information chanted by the instruction from the operator, the SCS 68 sends the change request of the LDAP server information to the UCS 67. The change request of the LDAP server information includes the generation number 1. When the UCS 67 receives the change request from the SCS 68, the UCS 67 compares the generation number 1 included in the change request with the generation number 1 of the LDAP server information stored and managed in the HDD 108 or the like.

In this case, since both generation numbers are the same, the UCS 67 changes the LDAP server information in response to the change request from the SCS 68, and changes the generation number to be “2”. In step S106 following to the step S105, the UCS 67 sends the setting completion of the LDAP server information to the SCS 68.

In step S107, based on the LDAP server information changed by the instruction from the operator, the client 232-1 sends the change request of the LDAP server information to the UCS 67. The change request of the LDAP server information includes the generation number 1. When the UCS 67 receives the change request from the client 232-2, UCS 67 compares the generation number 1 included in the change request with the generation number 2 of the LDAP server information stored and managed in the HDD 108 or the like.

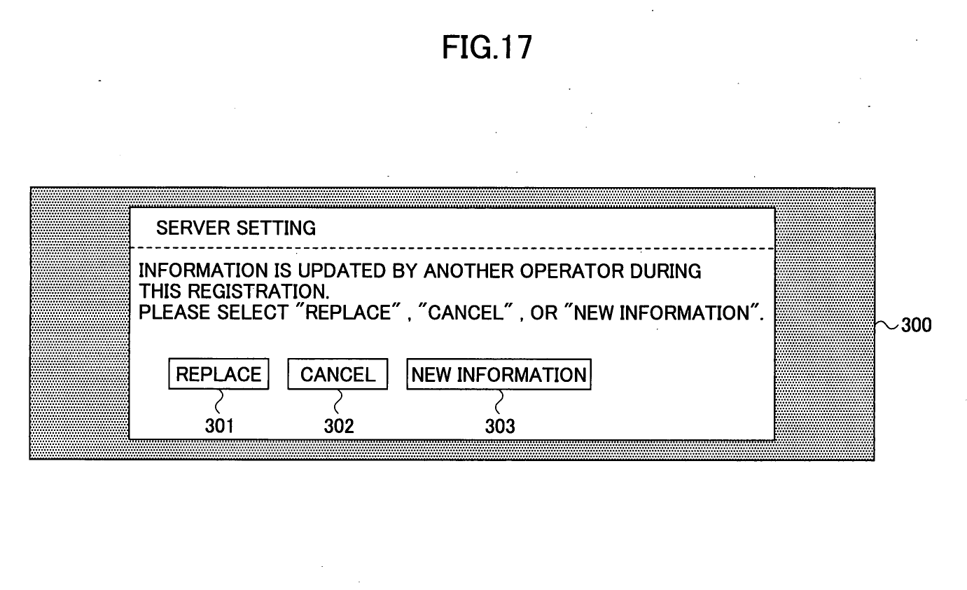

In this case, since both generation numbers are different each other, the UCS 67 does not change the LDAP server information in response to the change request from the client 232-1. In step S108 following to the step S107, the UCS 67 sends information showing a mismatch of the generation number to the client 232-1. When the clinet 232-1 receives the information showing the mismatch of the generation number from the UCS 67, for example, the client 232-1 displays a selection screen as shown in FIG. 17 at a display unit.

FIG. 17 is an image diagram illustrating a selection screen according to the fourth embodiment of the present invention. In FIG. 17, the selection screen 300 is displayed to allow the operator to select a process when the generation number does not match with that of the multi-functional apparatus 31, and includes a “REPLACE” button 301 for replacing with the LDAP server information indicated by the change request, a “CANCEL” button 302 for canceling the change request, and a “NEW INFORMATION” button 303 for saving as new information. In addition, as a message showing contents in that the LDAP server information is upadated by another operator and contents prompting to select one process, for example, the selection screen 300 includes a message showing “INFORMATION IS UPDATED BY ANOTHER OPERATOR DURING THIS REGISTRATION. PLEASE SELECT “REPLACE”, “CANCEL”, OR “NEW INFORMATION”.”.

When the operator select one of the “REPLACE” button 301, the “CANCEL” button 302, and the “NEW INFORMATION” button 303, the client 232-1 advances to step S109 and sends information showing the process selected by the operator as a selection result to the UCS 67.

In step S110 following to the step S109, the UCS 67 determines whether or not the selection result shows a cancel. When it is determined that the selection result shows the cancel (YES of the step S110), the UCS 67 does not change the LDAP server information in response to the change request from the client 202-1. Then, the UCS 67 sends a cancel completion to the SCS 68.

When it is determined that the selection result does not show the cancel (NO of the step S110), the UCS 67 advances to step S111 and determines whether or not the selection result shows a replace. When it is determined that the selection result shows the replace (YES of the step S11), the UCS 67 changes the LDAP server information in response to the change request from the client 232-1 and changes the generation number to be “3”. Then, the UCS 67 sends a replace completion to the SCS 68. When it is determined that the selection result does not show the replace (NO of the step Sill), the UCS 67 registers the LDAP server information of the generation number 1 corresponding to the change request from the client 232-1 as new information.

In the sequence diagram of FIG. 16, the operator is allowed to select the following process for the change request which generation number does not match with the generation number at the multi-functional apparatus 31. As a result, the operator can consider an importance of the consistency of the LDAP server information and can properly select the following process for the obtain request, the add request, the change request, the delete request, and the search request in which the generation number does not match with the generation number at the multi-functional apparatus 31.

[Fifth Embodiment]

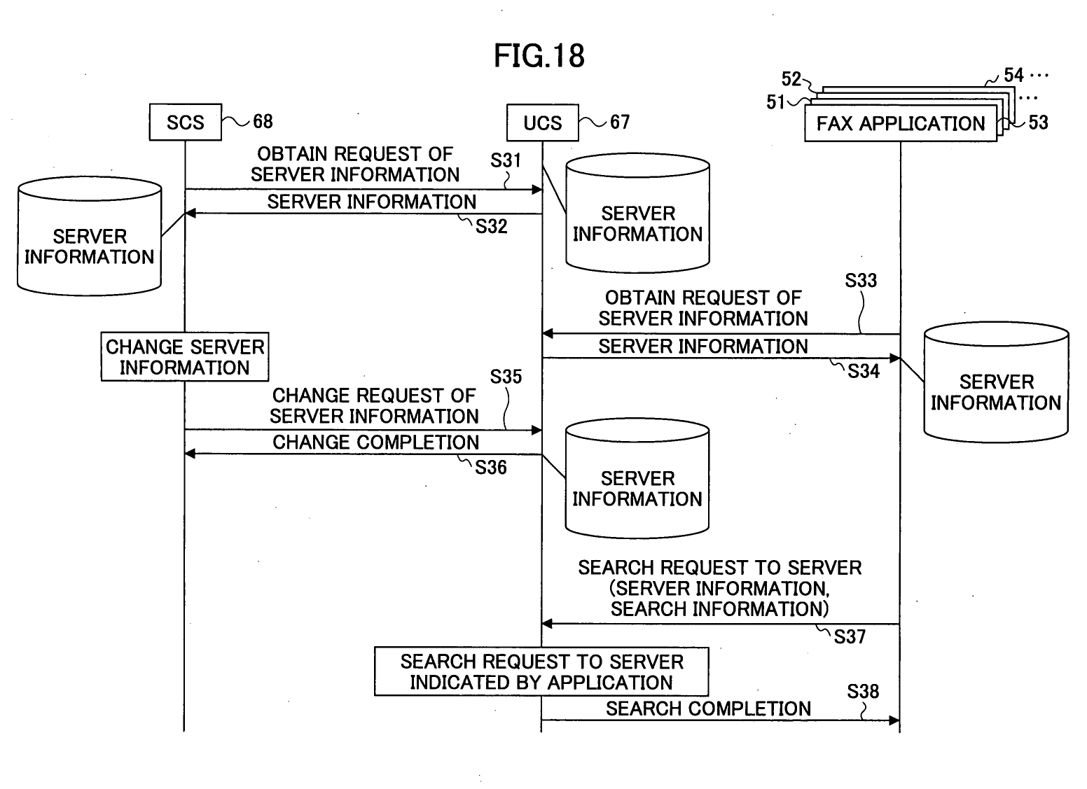

FIG. 18 is a sequence diagram for explaining a sequence process in that the change process for changing the LDAP server information and a process using the LDAP server information are simultaneously conducted, according to a fifth embodiment of the present invention. The LDAP server information shown in FIG. 18 is not associated with the generation number and does not include the generation number information showing the generation number.

In step S31, the SCS 68 sends an obtain request of the LDAP server information to the UCS 67. The UCS 67 reads out the LDAP server information from the HDD 108 in response to the obtain request from the SCS 68. In step S32 following to the step S31, the UCS 67 provide the LDAP server information read out in the step S31 to the SCS 68. After step S32, the SCS 68 changes the LDAP server information by the instruction from the operator.

In step S33, for example, the fax application 53 sends an obtain request to the UCS 67. The UCS 67 reads out the LDAP server information in response to the obtain request from the fax application 53. In step S34 following the step S35, the UCS 67 provides the LDAP server information read out in the step S33 to the fax application 53.

In step S35, based on the LDAP server information changed by the instruction from the operator, the SCS 68 sends the change rquest of the LDAP server information to the UCS 67. When the UCS 67 receives the change request from the SCS 68, the UCS 67 changes the LDAP server information in response to the change request from the SCS 68. In step S36 following to the step S35, the UCS 67 sends a change completion of the LDAP server information to the SCS 68.

In step S37, the fax application 53 sends a search request using the LDAP server information to the UCS 67. The LDAP server information obtained in the step S34 and search information necessary to search are sent to the UCS 67 with the search request.

In this case, since the LDAP server information stored and managed in the HDD 108 or the like by he UCS 67 is changed in response to the change request in the step S35, the LDAP server information stored in the HDD 108 is different from the LDAP server information received from the fax application 53. However, when the UCS 67 receives the fax application 53, for example, the UCS 67 sends the search request of the user information to the LDAP server 231-1 indicated by the LDAP server information by using the LDAP server information and the search information received from the fax application 53.

This case is based on a concept in that even if the LDAP server information is slightly changed, there is no case in that the LDAP server 231-1 being currently used is not available suddenly. In this case, a search process may be failed because of a change of the LDAP server information. However, the fax application 53 can conduct the search process using the LDAP server information by repeating the process from the obtain request of the LDAP server information if the fax application 53 fails to conduct the search process.

After the step S37, the UCS 67 receives a search request response from the LDAP server 231-1. When the UCS 67 receives the search request response, the UCS 67 advances to step S38 and sends a search completion to the fax application 53 in response to the search request response.

The search completion includes information showing a success or failure of the search, information showing a reason of the failure of the search (for example, a timeout, more than a maximum hit number, an authentication failure, another failure, or a like) and a like.

In the sequence diagram of FIG. 18, even if the LDAP server information managed by the UCS 67 is different from the LDAP server information received from the fax application 53, it is possible to conduct the search request in response to the LDAP server information received from the fax application 53. Therefore, it is possible to preferably suppress an influence when another request is redundantly conducted.

[Sixth Embodiment]

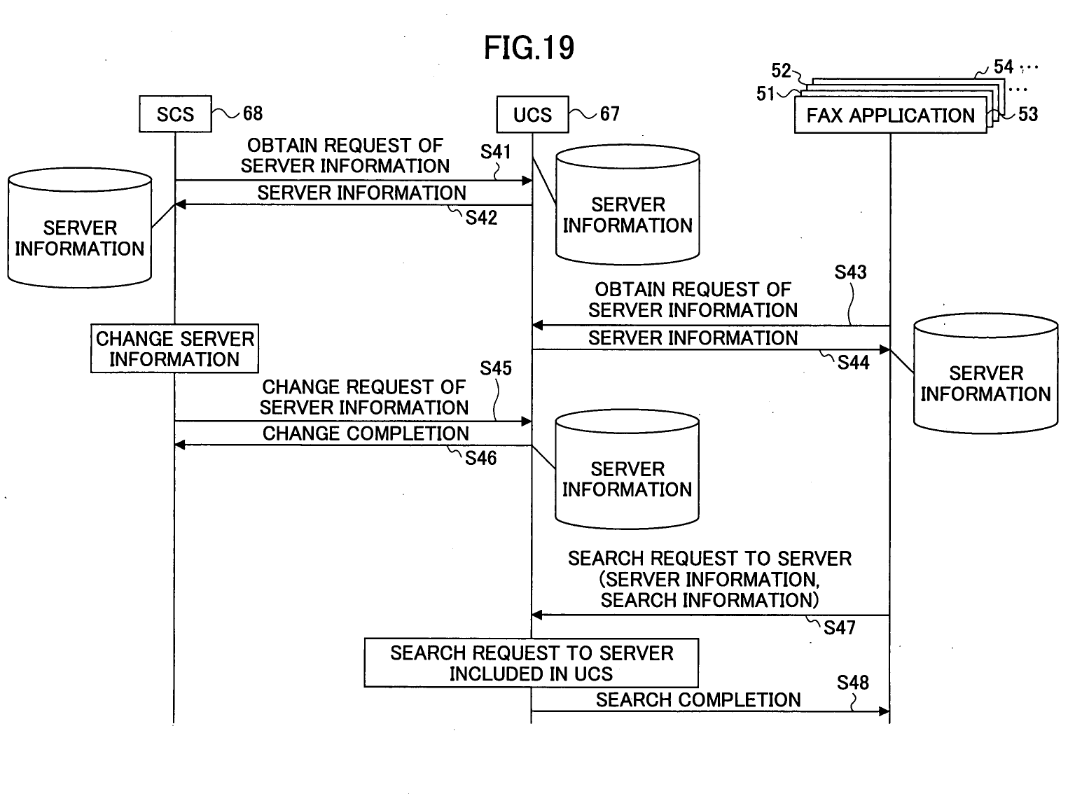

FIG. 19 is a sequence diagram for explaining a first variation of the sequence process in that the change process for changing the LDAP server information and the process using the LDAP server information are simultaneously conducted, according to a sixth embodiment of the present invention. The LDAP server information shown in FIG. 19 is not associated with the generation number, and does not include the generation number information showing the generation number. In the sequence diagram in FIG. 19, parts that are the same as the ones in FIG. 18 are indicated by the same reference numerals and the explanation thereof will be omitted.

Steps S41 through S46 in FIG. 19 are the same as the steps S31 through S36 in FIG. 18. In step S47, the fax application 53 sends the search request using the LDAP server information to the UCS 67. The fax application 53 sends the LDAP server information obtained in the step S44 and search information necessary for a search to the UCS 67 with the search request.

In this case, since the LDAP server information stored and managed in the HDD 108 or the like by he UCS 67 is changed in response to the change request in the step S45, the LDAP server information in the HDD 108 is different from the LDAP server information received from the fax application 53. Accordingly, the UCS 67 sends a search request of the user information to the LDAP server 231-1 by using the LDAP server information stored and managed in HDD 108 or the like and the search information.

In this case, since the LDAP server information is changed by the change request in the step S45, instead of using the LDAP server information received from the fax application 53 before this change, the LDAP server information stored and managed in the HDD 108 or the like after this change is used for the search request.

After the step S47, the UCS 67 receives a search request response from the LDAP server 231-1. The UCS 67 advances to step S48 when the UCS 67 receives the search request response, the UCS 67 sends a search completion in response to the search request response. The search request response includes information showing a success or failure of the search, and information showing a reason of the failure of the search.

In the sequence diagram of FIG. 19, even if the LDAP server information managed by the UCS 67 is different from the LDAP server information received from the fax application 53, it is possible to conduct the search request in response to the LDAP server information managed by the UCS 67. Accordingly, even if another request is redundantly conduct, no problem occurs.

[Seventh Embodiment]

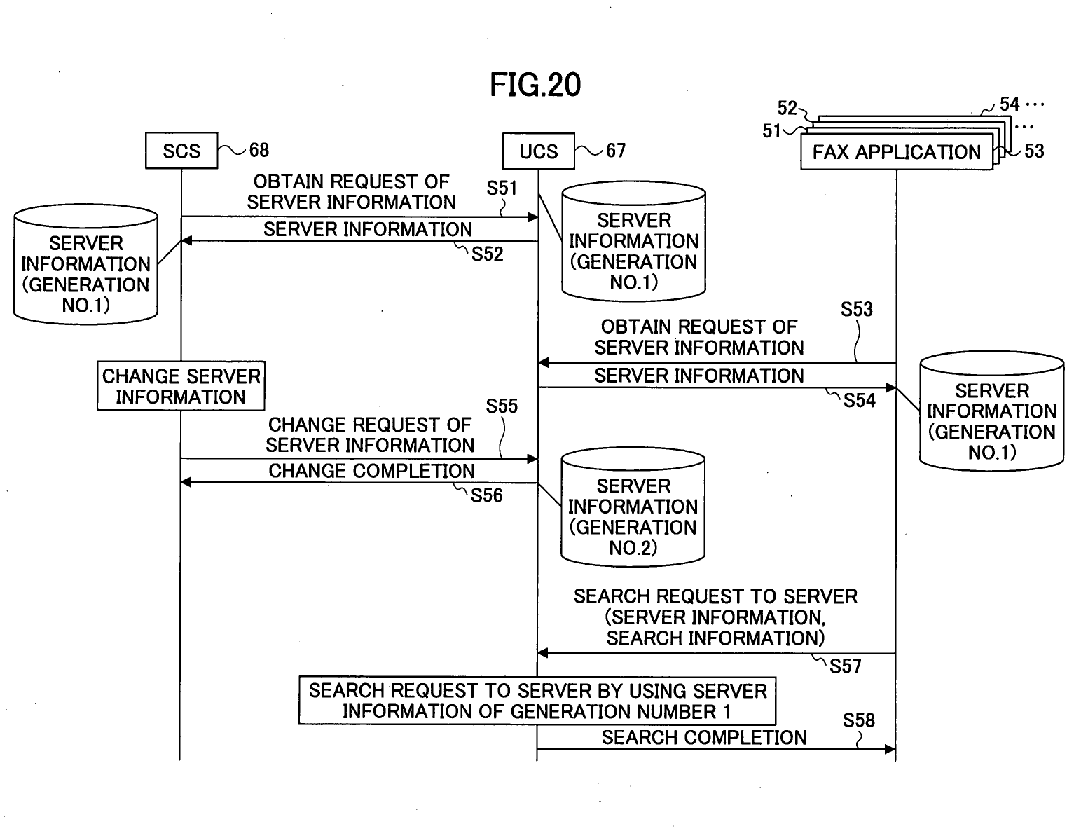

FIG. 20 is a sequence diagram for explaining a second variation of the sequence process in that the change process for changing the LDAP server information and the process using the LDAP server information are simultaneously conducted, according to a seventh embodiment of the present invention. The LDAP server information shown in FIG. 20 is associated with the generation number, and includes the generation number information showing the generation number.

In step S51, the SCS 68 sends an obtain request of the LDAP server information to the UCS 67. The UCS 67 reads out the LDAP server information in response to the obtain request from the SCS 68. In this case, the LDAP server information of the generation number 1 is read out. In step S52 following to the step S51, the UCS 67 provides the LDAP server information of the generation number 1 read out from the HDD 108 or the like to the SCS 68. After the step S52, the SCS 68 changes the LDAP server information by an instruction from the operator.

In step S53, for example, the fax application 53 sends an obtain request to the UCS 67. The UCS 67 reads out the LDAP server information in response to the obtain request from the fax application 53. In this case, the LDAP server information of the generation number 1 is read out. In step S54 following to the step S53, the UCS 67 provides the LDAP server information of the generation number 1 to the fax application 53.

In step S55, based on the LDAP server information changed by the instruction from the operator, the SCS 68 sends the change request of the LDAP server information to the UCS 67. The change request of the LDAP server information includes the generation number 1. When the UCS 67 receives the change request from the SCS 68, the UCS 67 compares the generation number 1 included in the change request with the generation number 1 of the LDAP server information stored and managed in HDD 108 or the like.

In this case, since both generation numbers are the same each other, the UCS 67 changes the LDAP server information in response to the change request and changes the generation number to be “2”. In step S57, the fax application 53 sends a search request using the LDAP server information to the UCS 67.

The search request using the LDAP server information includes the generation number 1. The LDAP server information obtained in the step S54 and the search information necessary for a search are sent to the UCS 67 with the search request. When the UCS 67 receives the fax application 53, the UCS 67 compares the generation number 1 included in the search request with the generation number 2 of the LDAP server information stored and managed in the HDD 108 or the like.

In this case, since the generation number of the LDAP server stored and managed in the HDD 108 or the like by the UCS 67 is changed in response to the change request in step S55, the generation number is different form the generation number 1 of the LDAP server information received from the fax application 53. The UCS 67 sends a search request of the user information by using the LDAP server information stored and managed in the HDD 108 or the like and the search information received from the fax application 53.

After the step S57, the UCS 67 receives a search request response from the LDAP server 231-1. When the UCS 67 receives the search request response, the UCS 67 advances to step S58 nad sends a search completion to the fax application 53 in response to the search request response.

The search completion includes information showing a success of the search (including information showing a match of the generation number or a mismatch of the generation number), information showing a failure of the search, information showing a reason of the failure of the search (for example, a timeout, more than a maximum hit number, an authentication failure, another failure, or a like), and a like.

The information of the match of the generation number included in the information showing the success of the search shows that the generation number included in the search request matches with the generation number of the LDAP server information stored and managed in the HDD 108 or the like. The information showing the mismatch of the generation number included in the information showing the success of the search shows that the generation number included in the search request mismatches with the generation number of the LDAP server information stored and managed in the HDD 108 or the like.

In the sequence diagram of FIG. 20, even if the generation number of the LDAP server information managed by the UCS 67 is different from the generation number of the LDAP server information received from the fax application 53, it is possible to conduct the search request in response to the LDAP server information managed by the UCS 67. Therefore, even if another request is redundantly conducted, no problem occurs.

In addition, by including the information showing the mismatch of the generation number in the search completion, it is possible to inform the fax application 53 that the generation number of the LDAP server information managed by the UCS 67 is different from the generation number of the LDAP server information received from the fax application 53 is different from.

[Eighth Embodiment]

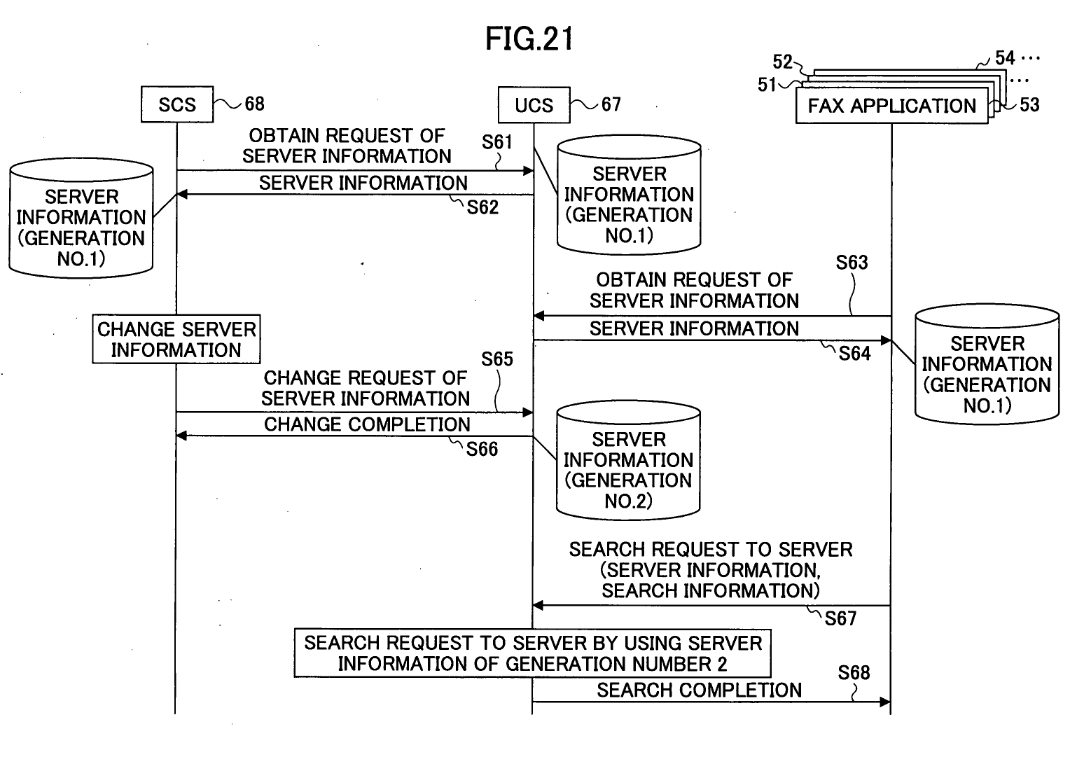

FIG. 21 is a sequence diagram for explaining a third variation of the sequence process in that the change process for changing the LDAP server information and the process using the LDAP server information are simultaneously conducted, according to an eighth embodiment of the present invention. The LDAP server information shown in FIG. 21 includes the generation number information showing the generation number. In the sequence diagram in FIG. 21, parts that are the same as the ones in FIG. 20 are indicated by the same reference numerals and the explanation thereof will be omitted.

Steps S61 through S66 are the same as the steps S51 through S56 in FIG. 20. In step S67, the fax application 53 sends a search request using the LDAP server information to the UCS 67. The search request using LDAP server information includes an LDAP server ID. Search information necessary for a search is sent to the UCS 67 with the search request.

When the UCS 67 receives the search request from the fax application 53, the UCS 67 obtains the LDAP server ID from the search request received from the fax application 53 and reads out the LDAP server information of the latest generation number corresponding the LDAP server ID from all LDAP server information.

In this case, since the generation number of the LDAP server information managed by the UCS 67 is changed to the latest generation number 2 in response to the change request in the step S55, the LDAP server information of the generation number 2 is reads out from the HDD 108 or the like. Then, for example, the UCS 67 sends a search request of the user information to the LDAP server 231-1 by using the LDAP server information managed in the HDSS 108 or the like and the search information received from the fax application 53.

After the step S67, the UCS 67 receives a search request response from the LDAP server 231-1. The UCS 67 advances to step S68 when the UCS 67 receives the search request response and sends a search completion to the fax application 53 in response to the search request response.

This search completion includes information showing a success or failure of the search, information showing a reason when the search is failed (for example, a timeout, more than a maximum hit number, an authentication failure, another failure, or a like), and a like.

In the sequence diagram of FIG. 21, since the LDAP server information of the latest generation number in all LDAP server information managed by the UCS 67, even if another request is redundantly conducted, no problem occurs.

[Ninth Embodiment]

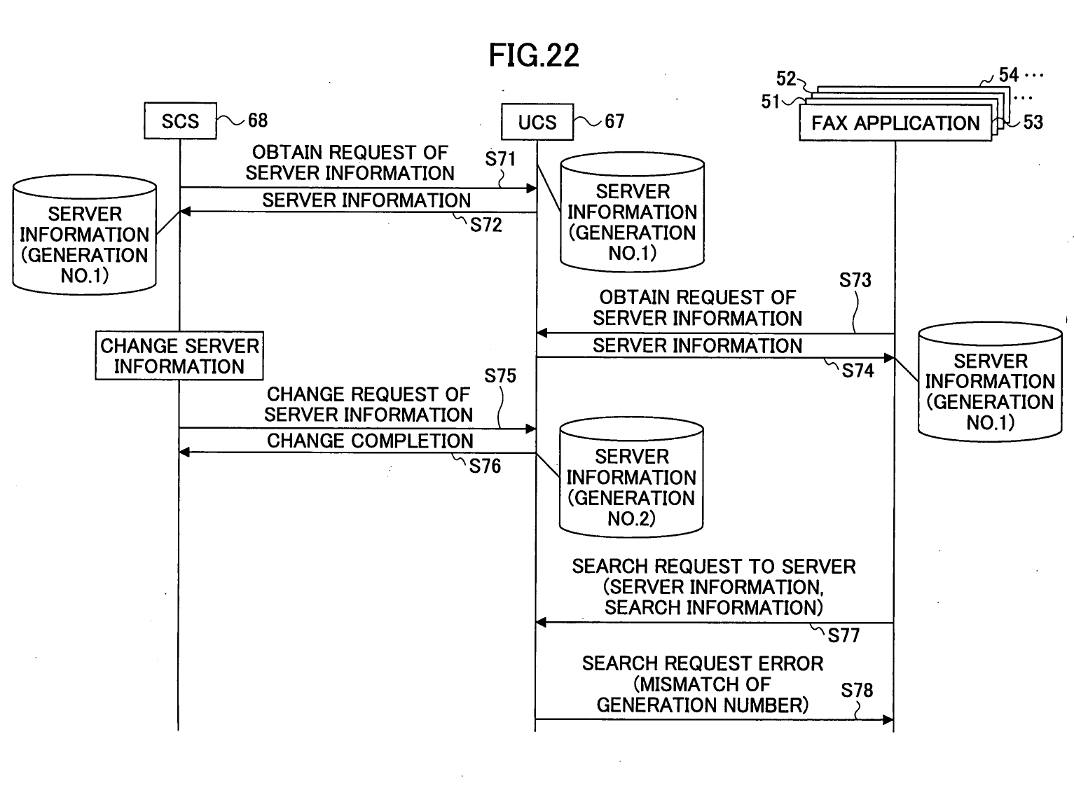

FIG. 22 is a sequence diagram for explaining a fourth variation of the sequence process in that the change process for changing the LDAP server information and the process using the LDAP server information are simultaneously conducted, according to a ninth embodiment of the present invention. The LDAP server information shown in FIG. 22 includes generation number information showing the generation number. In the sequence diagram in FIG. 22, parts that are the same as the ones in FIG. 20 are indicated by the same reference numerals and the explanation thereof will be omitted.

Steps S71 through S76 are the same as the steps S51 through S56 in FIG. 20. In step S77, the fax application 53 sends a search request using the LDAP server information to the UCS 67. The search request using LDAP server information includes the generation number 1. The LDAP server information obtained in the step S74 and search information necessary for a search are sent to the UCS 67 with the search request.

When the UCS 67 receives the search request from the fax application 53, the UCS 67 compares the generation number 1 included in the search request with the generation number 2 of the LDAP server information stored and managed in the HDD 108 or the like.

In this case, since both generation numbers are different each other, the UCS 67 does not send the search request of the user information in response to the search request from the fax application 53. If both generation numbers are the same each other, the UCS 67 sends the search request of the user information in response to the search request from the fax application 53.

In step S78 following to the step S77, the UCS 67 informs a search request error caused by a mismatch of the generation number to the fax application 53. The fax application 53 can conduct the search process using the LDAP server information by repeating the process form the obtain request of the LDAP server information.

In the sequence diagram of FIG. 22, since it is possible to conduct a process using the LDAP server information in response to the search request only if both generation numbers are the same, even if another request is redundantly conducted, no problem occurs.

According to the present invention, it is possible to provide the information processing apparatus, the image forming apparatus, and the information processing method in that an update or an access of the connection information can be effectively conducted.

The present invention is not limited to the specifically disclosed embodiments, and variations and modifications may be made without departing from the scope of the present invention.

What is claimed is:

1. An information processing apparatus capable of obtaining information from an information storing server utilized in common by a least one information processing apparatuses, comprising:
a connection information managing part managing connection information for connecting to the information storing server, receiving a request concerning the connection information, and conducting a process corresponding to the request; and
a requesting part conducting a request concerning the connection information;
wherein said connection information managing part receives one of an obtain request, an add request, a change request, and a delete request of connection information as the request, and conducts the process corresponding to the obtain request, the add request, the change request, or the delete request.

2. The information processing apparatus as claimed in claim 2, wherein said connection information managing part manages a generation number, which is changed every time the connection information is updated, by associating with the connection information.

3. The information processing apparatus as claimed in claim 2, wherein said connection information managing part determines whether or not a generation number included in the add request, the change request, or the delete request matches with the generation number associated with the connection information.

4. The information processing apparatus as claimed in claim 3, wherein said connection information managing part conducts the process corresponding the add request, the change request, or the delete request, when the generation number included in the add request, the change request, or the delete request matches with the generation number associated with the connection information.

5. The information processing apparatus as claimed in claim 3, wherein said connection information managing part cancels conducting the process corresponding to the add request, the change request, or the delete request, when the generation number included in the add request, the change request, or the delete request mismatches with the generation number associated with the connection information.

6. The information processing apparatus as claimed in claim, wherein said connection information managing part outputs a message showing a mismatch of the generation number and conducts the process corresponding to the add request, the change request, or the delete request, when the generation number included in the add request, the change request, or the delete request mismatches with the generation number associated with the connection information.

7. The information processing apparatus as claimed in claim 3, wherein said connection information managing part displays a message showing a mismatch of the generation number and outputs a screen for a user to select to conduct the process corresponding the request or not, when the generation number included in the add request, the change request, or the delete request mismatches with the generation number associated with the connection information.

8. The information processing apparatus as claimed in claim 1, wherein said connection information managing part receives a request concerning the connection information from a client directly or indirectly connected to said information processing apparatus.

9. An information processing apparatus capable of obtaining information from an information storing server utilized in common by a least one information processing apparatuses, comprising:
a connection information managing part managing connection information for connecting to the information storing server, receiving a first request using the connection information, and sending a second request of conducting a process corresponding to the first request to the information storing server corresponding to the connection information; and
a request sending part sending a third request using the connection information,
wherein said connection information managing part receives a search request as the third request from the request sending part and searches for information stored in the information storing server in response to the search request.

10. The information processing apparatus as claimed in claim 9, wherein when said connection information managing part receives the search request using the connection information, said connection information sends a search request to the information storing server by using the connection information received by the requesting part.

11. The information processing apparatus as claimed in claim 9, wherein when said connection information managing part receives the search request using the connection information, said connection information managing part sends a search request to the information storing server by using the connection information stored by said connection information managing part.

12. The information processing apparatus as claimed in claim 9, wherein said connection information managing part manages the generation number, which is changed each time the connection information is updated, by associating with the connection information.

13. The information processing apparatus as claimed in claim 12, wherein when said connection information managing part receives the search request using the connection information, said connection information managing part sends a search request to the information storing server by using the connection information received by the requesting part, and informs information showing a match or mismatch of the generation number included in the search request and the generation number associated with the connection information to the requesting part.

14. The information processing apparatus as claimed in claim 12, wherein when said connection information managing part receives the search request using the connection information, said connection information managing part sends a search request to the information storing server by using the connection information managed by the connection information managing part.

15. The information processing apparatus as claimed in claim 12, wherein when said connection information managing part receives the search request using the connection information, said connection>information managing part sends a search request to the information storing server by using the received connection information, when the generation number included in the search request matches with the generation number associated with the connection information.

16. The information processing apparatus as claimed in claim 12, wherein when said connection information managing part receives the search request using the connection information, the said connection information managing part cancels a search process and informs an error to said requesting part when the generation number included in the search request mismatches with the generation information associated with the connection information.

17. The information processing apparatus as claimed in claim 12, wherein when the generation number included in the search request mismatches with the generation number associated with the connection information, said connection information managing part outputs a message showing a mismatch of the generation number and sends a search request to said information storing server by using the received connection information.

18. The information processing apparatus as claimed in claim 12, wherein when the generation number included in the search request mismatches with the generation number associated with the connection information, said connection information managing part displays a message showing a mismatch of the generation number and output a screen for a user to select to conduct the process corresponding to the search request or not.

19. An image forming apparatus including at least one hardware resource used in an image forming process, at least one program conducting a process according to an image form, and a platform managing a use of the hardware resource by said at least one program, comprising:
a connection information managing part managing connection information for connecting to an information storing server utilized in common by at least one image forming apparatus or information processing apparatus, receiving a request concerning the connection information, and conducting a process corresponding to the request; and
a requesting part conducting a request concerning the connection information,
wherein said connection information managing part receives one of an obtain request, an add request, a change request, or a delete request of connection information as the request, and conducts the process corresponding to the obtain request, the add request, the change request, or the delete request.

20. An image forming apparatus including at least one hardware resource used in an image forming process, at least one program conducting a process according to an image form, and a platform managing a use of the hardware resource by said at least one program, comprising:
a connection information managing part managing connection information for connecting to the information storing server, receiving a first request using the connection information, and sending a second request of conducting a process corresponding to the first request to the information storing server corresponding to the connection information; and
a request sending part sending a third request using the connection information,
wherein said connection information managing part receives a search request as the third request from the request sending part and searches for information stored in the information storing server in response to the search request.

21. The image forming apparatus as claimed in claim 19, wherein said requesting part is application software according to the image form.

22. An information processing method conducted by the information processing apparatus capable of obtaining information from an information storing server utilized in common by a least one information processing apparatuses, comprising the steps of:
receiving a request concerning connection information for connecting to the information storing server; and
receiving a request concerning the connection information and conducting a process corresponding to the request,
whereby one of an obtain request, an add request, a change request, and a delete request of connection information is received as the request, and a process corresponding to the obtain request, the add request, the change request, or the delete request is conducted.

23. An information processing method conducted by the information processing apparatus capable of obtaining information from an information storing server utilized in common by a least one information processing apparatuses, comprising the steps of:
receiving a request using connection information for connecting to the information storing server;
requesting a process corresponding to the request to the information storing server corresponding to the connection information; and
receiving a request response from the information storing server corresponding the connection information,
whereby a search request is received as the request, information stored in the information storing server is searched for in response to the search request.
